(19) United States
(12) Patent Application Publication
(10) Pub. No.: US 2018/0010375 A1
(43) Pub. Date: Jan. 11, 2018

(54) Door Drive Device Having a Main Drive and Auxiliary Drive

(71) Applicant: ASSA ABLOY Sicherheitstechnik GmbH, Albstadt (DE)

(72) Inventors: Andreas Sauter, Messstetten (DE); Stefan Fischbach, Ochsenhausen (DE)

(21) Appl. No.: 15/543,382

(22) PCT Filed: Jan. 18, 2016
(86) PCT No.: PCT/EP2016/050933

§ 371 Date: Jul. 13, 2017

(30) Foreign Application Priority Data
Jan. 18, 2015 (DE) 10 2015 000 513.8
Jan. 18, 2015 (DE) 10 2015 000 514.6
Jan. 18, 2015 (DE) 10 2015 000 515.4
Jan. 18, 2015 (DE) 10 2015 000 516.2
Jan. 20, 2015 (DE) 10 2015 100 734.7
Apr. 30, 2015 (DE) 10 2015 106 827.3
Nov. 5, 2015 (DE) 10 2015 118 961.5

(51) Int. Cl. E05F 3/10; E05F 1/10; E05F 3/22; E05F 5/02

(52) U.S. Cl. CPC E05F 3/10; E05F 3/222; E05F 3/227; E05F 1/10; E05F 2003/228; E05Y 2900/132; E05F 5/027

(57) ABSTRACT

A door drive mechanism includes a main drive and an auxiliary drive.

In this connection it is provided that the components of the main drive and of the auxiliary drive to be mounted on the door leaf side are borne in or on a common and/or continuous housing mechanism and/or bearing framework mechanism and/or mounting plate mechanism to be mounted on the door leaf side and/or are covered by a common and/or continuous cover to be mounted on the door leaf side.

From DE 3 742 213 A1, e.g., manual door drives are known which have a drive assembly with a force-transmitting mechanism and are formed to be mounted on doors with a swing door leaf. The drive assembly is mounted on the leaf side or on the frame side depending on local conditions and the application case. The force-transmitting mechanism is supported on the opposite side, i.e. on the frame side or on the leaf side respectively. In this known manual door drive, the drive assembly comprises a closing spring unit and a hydraulic damper. The closing spring unit and the hydraulic damper are accommodated in a housing in which the output shaft to which the force-transmitting mechanism is connected is also borne. In practice the latter can be designed as a scissor arm mechanism or slide arm-slide rail mechanism.

An electromechanical door drive which is comparably formed from a drive assembly and a corresponding force-transmitting mechanism is known e.g. from EP 1 505 239 B1. The drive assembly comprises an electric motor, the output shaft of which is connected to the force-transmitting mechanism which, in the same way as in the case of the above-named manual door closer, can be formed as a scissor arm mechanism or slide arm-slide rail mechanism. The electromechanical drive is mounted, in a comparable way, on a door with a swing door leaf, as described previously for the manual door closer.

An important function of manual and electromechanical door drives is that, at the end of the closing process, the door must securely reach the closed position in the lock, overcoming the falling latch. For this, as a rule, in the known manual door closers with hydraulic damping, a so-called hydraulic end stop is provided which consists in the hydraulic damping having a bypass in the end phase during the closing process. In practice this often causes the door to be slammed shut with a loud noise when the door is clicked shut. If the end stop is set to be weaker, it can be the case that the spring force of the closing spring is insufficient at the end of the closing process to close the door, i.e. it can be the case that the door does not reach the closed position, the falling latch is not overridden and the door leaf remains only leant against the frame, before achieving the closed position.

In the known electric motor door drives, the motorized opening and/or closing process can be controlled via an electric control mechanism. However, in order for the drive to function reliably and safely, constant maintenance and control adjustments are required. A failure of electrical components, as a rule, leads to the complete shutdown of the drive, with the result that the named maintenance and testing measures are constantly required. Furthermore, the electric drive fundamentally requires a power connection. In practice, therefore, manual door drives are also often preferred.

Furthermore, door shutting devices and door dampers are also known which are used on doors in buildings and can be coupled to the door during the closing and opening process only close to the closed end position, and thus act on the door only in this partial area of the closing and opening process. These drive mechanisms likewise have a drive assembly to be mounted on the frame side or on the leaf side with a force-transmitting mechanism, having, however, a rod system which can be coupled in and out automatically. Such a drive with a rod system which can be coupled in and out automatically is described in EP 2 468 998 A1. The drive assembly, in a comparable way to the case of a manual hydraulic door closer, has a spring brake with a hydraulic damper which interacts with a slide arm on the output side, which automatically couples into and out of a slide rail during the closing and opening process.

U.S. Pat. No. 2,190,653 describes a conventional hydraulic door closer with scissor arm in combination with a door shutting device which, as described, automatically couples out of and into a hinge bearing during the closing and opening process.

The object of the invention is to create a drive system composed of a main drive and an auxiliary drive such that the drive can be mounted in a practical way and brings advantages to the door during operation.

The invention achieves this object with the subject of claim 1.

This door drive mechanism is a door drive mechanism for a door of a building with a door leaf borne pivotably about a vertical door axis in a fixed frame. The door drive mechanism is composed of a main drive and an auxiliary drive.

The main drive is formed to act on the door leaf in the direction of the closing movement and/or opening movement and/or closing damping and/or opening damping, preferably as a manual closing spring drive or as an electric-motor drive. It comprises a drive assembly of its own and a force-transmitting mechanism of its own.

The auxiliary drive is formed to act on the door leaf in the direction of the closing movement and/or opening movement and/or closing damping and/or opening damping. For this, the auxiliary drive comprises a drive assembly of its own and a force-transmitting mechanism of its own.

It is important that the main drive has one or more component(s) to be mounted on the door leaf side and one or more component(s) to be mounted on the frame side, which can be or are connected via a force-transmitting connecting mechanism of the force-transmitting mechanism of the main drive. This means that the main drive has at least one component to be mounted on the door leaf side and at least one component to be mounted on the frame side, which can be and/or are connected via the force-transmitting connecting mechanism of the force-transmitting mechanism of the main drive.

With regard to the auxiliary drive, it is provided that the auxiliary drive also has one or more component(s) to be mounted on the door leaf side and one or more component(s) to be mounted on the frame side, which can be and/or are connected via a force-transmitting connecting mechanism of the force-transmitting mechanism of the auxiliary drive. This means that the auxiliary drive also has at least one component to be mounted on the door leaf side and at least one component to be mounted on the frame side, which can be and/or are connected via the force-transmitting connecting mechanism of the force-transmitting mechanism of the auxiliary drive.

The solution according to the invention comprises the ‘and/or’ alternatives (i), (ii) and (iii), as named in the characterizing part of main claim 1.

The ‘and/or’ alternative (i) provides, for the components to be mounted on the door leaf side, that the components of the main drive and of the auxiliary drive to be mounted on the door leaf side are borne in or on a common and/or continuous housing mechanism and/or bearing framework mechanism and/or mounting plate mechanism to be mounted on the door leaf side and/or are covered by a common and/or continuous cover to be mounted on the door leaf side.

The ‘and/or’ alternative (ii) provides, for the components to be mounted on the frame side, that the components of the main drive and of the auxiliary drive to be mounted on the frame side are borne in or on a common and/or continuous housing mechanism and/or bearing framework mechanism and/or mounting plate mechanism to be mounted on the frame side and/or are covered by a common and/or continuous cover to be mounted on the frame side.

The components to be mounted on the leaf side and the components to be mounted on the frame side can be equipped, as a structural unit or pre-assembled group of components, primarily for mounting purposes, with the common and/or continuous housing mechanism and/or bearing framework mechanism and/or mounting plate mechanism to be mounted on the leaf side or on the frame side provided according to (i) or (ii) respectively.

The common and/or continuous cover furthermore provided as ‘and/or’ alternatives (i) and (ii), with which the components to be mounted on the leaf side can be covered uniformly or the components to be mounted on the frame side can be covered uniformly, also bring, in addition to substantial visual and aesthetic advantages, advantages for the mounting and a reduction in the production costs, as it is possible to economize on separate covers for the individual components.

With regard to the number of components to be mounted on the leaf side and of components to be mounted on the frame side, it is important that the main drive has in each case at least one component to be mounted on the leaf side and in each case at least one component to be mounted on the frame side. Preferred embodiments with the common and/or continuous housing mechanism and/or bearing framework mechanism and/or mounting plate mechanism and/or cover to be mounted on the leaf side or on the frame side in each case provide that preferably all of the components to be mounted on the leaf side are provided with such a common and/or continuous mechanism and/or preferably all of the components to be mounted on the frame side are provided with such a common and/or continuous mechanism.

The ‘and/or’ alternative (iii) provides, for the components of main drive and auxiliary drive to be mounted on the leaf side and/or for the components of main drive and auxiliary drive to be mounted on the frame side, a concealed and/or internal mounting in the leaf or in the frame respectively.

Alternative (iii), part 1, provides that the components of the main drive and of the auxiliary drive to be mounted on the door leaf side are formed to be mounted concealed and/or internally in the leaf.

Alternative (iii), part 2, provides that the components of the main drive and of the auxiliary drive to be mounted on the frame side are formed to be mounted concealed and/or internally in the frame.

The internal and/or concealed mounting brings advantages for the drive mechanism according to the invention, because the larger number of components of the drive mechanism according to the invention resulting because of the division into main drive and auxiliary drive is visible without disruption in the assembled state.

A further aspect is that, because of the division of the drive mechanism into main drive and auxiliary drive, the individual components can have a smaller installation size than in the case of a conventional, undivided drive mechanism. This means in turn that, due to the smaller installation size of the components, an internal and/or concealed mounting in the leaf or in the frame is particularly favored with the system according to the invention. The common mechanisms provided according to the ‘and/or’ alternatives (i) and (ii), with which the leaf-side components and the frame-side components can be combined into groups of components, can also be used advantageously in the case of an internal and/or concealed mounting. The groups of components in question can be installed recessed in corresponding, preferably continuous common receivers in the leaf or in the frame, preferably in groove-shaped receivers or receiver pockets, continuous over the entire leaf width, in the leaf or in the frame.

This means that both in the case of an overlying mounting and in the case of a concealed and/or internal mounting, the common and/or continuous mechanisms which combine the components into the groups of manufacturing components and/or groups of mounting components are particularly advantageous.

Particularly advantageous specifications of these common mechanisms can be provided, both for the overlying mounting and for the concealed and/or internal mounting, in the following embodiment features.

With regard to embodiments with a common and/or continuous housing mechanism, it can preferably be provided that the common and/or continuous housing mechanism to be mounted on the frame side and/or the common and/or continuous housing mechanism to be mounted on the leaf side is or are formed surrounding the components borne therein in their entirety on several sides.

With regard to embodiments with a common and/or continuous bearing framework mechanism, it can preferably be provided that the common and/or continuous bearing framework mechanism to be mounted on the frame side and/or to be mounted on the leaf side is formed as a three-dimensional body, on or in which the components borne thereon can be fastened, optionally by fastening the components to each other.

With regard to embodiments with a common and/or continuous mounting plate mechanism, it can preferably be provided that the common and/or continuous mounting plate mechanism to be mounted on the door leaf side and/or to be mounted on the frame side is formed as a plate-shaped element, on the upper side of which the components borne thereon can be arranged.

With regard to embodiments with a common and/or continuous cover, it can preferably be provided that the common and/or continuous cover to be mounted on the frame side and/or to be mounted on the leaf side is formed as a U-shaped cover or as a cap-shaped cover below or inside which the components covered thereby can be arranged.

With regard to embodiments with components which are mounted concealed and/or internally in the door, it can preferably be provided that the components of the main drive and/or of the auxiliary drive formed and/or provided to be mounted concealed and/or internally in the leaf and/or in the frame are accommodated in or on a common and/or continuous receiver mechanism which in the manner of a housing mechanism and/or bearing framework mechanism and/or mounting plate mechanism, which is formed as a mechanism for concealed and/or internal mounting in the door leaf or in the frame.

Furthermore, advantageous embodiments are also possible which provide that components of the main drive and of the auxiliary drive adjoining each other have fastening points which are formed for the mutual fastening of the components adjoining each other.

Embodiments are possible which provide that components of the main drive and of the auxiliary drive adjoining each other and to be mounted on the leaf side have fastening points which are formed for the mutual fastening of the components adjoining each other, and/or that components of the main drive and of the auxiliary drive adjoining each other and to be mounted on the frame side have fastening points which are formed for the mutual fastening of the components adjoining each other.

Embodiments are also advantageous which provide that components of the main drive and of the auxiliary drive adjacent to each other and to be mounted on the leaf side are fastened to or on connecting elements which connect these components to each other, and/or that components of the main drive and of the auxiliary drive adjacent to each other and to be mounted on the frame side are fastened to or on connecting elements which connect these components to each other.

Embodiments are possible in which it is provided that the one or more component(s) of the auxiliary drive to be mounted on the frame side is or are to be mounted in a mounting plane which is arranged on the front side or on the back side or above the upper side or below the underside of the one or more component(s) of the main drive to be mounted on the frame side.

Furthermore, it can be provided that the one or more component(s) of the auxiliary drive to be mounted on the frame side and the one or more component(s) of the main drive to be mounted on the frame side are borne in or on the common and/or continuous housing mechanism and/or bearing framework mechanism and/or mounting plate mechanism to be mounted on the frame side or are covered by the common and/or continuous cover to be mounted on the frame side or, in the case of concealed and/or internal mounting of the components of the main drive and of the auxiliary drive to be mounted on the frame side, are arranged in the common and/or continuous receiver mechanism formed in the frame.

In preferred embodiments, it can be provided that the drive assembly of the main drive is mounted on the door leaf side and the slide rail of the force-transmitting mechanism of the main drive is mounted on the frame side, that the auxiliary drive has one or more components mounted on the frame side—called component mechanism of the auxiliary drive mounted on the frame side in the following—which are mounted on the frame side in such a way that a mounting space remains free and/or is formed, which is determined for the mounting of at least one or more add-on functional components of the main drive interacting with the slide and/or the slide arm of the main drive and to be mounted on the frame side—called add-on functional component mechanism of the main drive in the following—wherein the mounting space extends from the slide rail of the main drive and/or from the movement track of the slide of the main drive guided in the slide rail or from the movement track of a part immovably connected to the slide of the main drive in the direction of the end of the door frame away from the hinge.

It can here be provided that the mounting space extends in a direction which is flush with or which has a parallel or angled offset relative to the direction of the movement track of the slide of the main drive.

It can preferably be provided that at least a part of the mounting space or all or a majority of the mounting space is arranged on the upper side of the slide rail of the main drive and/or of the component mechanism of the auxiliary drive mounted on the frame side or of a part of this component mechanism and/or is arranged on the underside of the slide rail of the main drive and/or of the component mechanism of the auxiliary drive mounted on the frame side or of a part of this component mechanism and/or is arranged on the front side of the slide rail of the main drive and/or of the component mechanism of the auxiliary drive mounted on the frame side or of a part of this component mechanism and/or is arranged on the back side of the slide rail of the main drive and/or of the component mechanism of the auxiliary drive mounted on the frame side or of a part of this component mechanism and/or is arranged inside the slide rail of the main drive and/or the component mechanism of the auxiliary drive mounted on the frame side or a part of this component mechanism.

Preferred embodiments can provide that at least a part of the mounting space is covered towards the outside by a cover plate or a cover housing.

It can be provided that at least a part of the mounting space is arranged inside a housing of the slide rail of the main drive and/or a housing of the drive assembly of the auxiliary drive or a housing of the slide rail of the auxiliary drive.

The components of the main drive and auxiliary drive can be mounted arranged on the leaf and the frame in different combinations. In other words, in different embodiments, in each case different components can form the leaf-side components and the frame-side components.

In preferred embodiments, it can be provided that the components to be mounted on the door leaf side are formed by the drive assembly of the main drive and by the drive assembly of the auxiliary drive, and

that the components to be mounted on the frame side are formed by a part of the force-transmitting mechanism of the main drive to be mounted on the frame side and by a part of the force-transmitting mechanism of the auxiliary drive to be mounted on the frame side.

Embodiments are also possible which provide that the components to be mounted on the door leaf side are formed by the drive assembly of the main drive and a part of the force-transmitting mechanism of the auxiliary drive to be mounted on the door leaf side, and that the components to be mounted on the frame side are formed by a part of the force-transmitting mechanism of the main drive to be mounted on the frame side and by the drive assembly of the auxiliary drive.

It is furthermore also possible for the components to be mounted on the door leaf side to be formed by a part of the force-transmitting mechanism of the main drive to be mounted on the door leaf side and by the drive assembly of the auxiliary drive, and for the components to be mounted on the frame side to be formed by the drive assembly of the main drive and a part of the force-transmitting mechanism of the auxiliary drive to be mounted on the frame side.

Furthermore, embodiments are possible which provide that the components to be mounted on the door leaf side are formed by a part of the force-transmitting mechanism of the main drive to be mounted on the door leaf side and a part of the force-transmitting mechanism of the auxiliary drive to be mounted on the door leaf side, and that the components to be mounted on the frame side are formed by the drive assembly of the main drive and the drive assembly of the auxiliary drive.

Embodiments in which an electrically switchable locking mechanism is mounted on the door and this locking mechanism is mounted integrated in the door drive mechanism are particularly interesting. These are preferably embodiments which provide that the door drive mechanism has an electrically switchable lock which is formed by a lock component to be mounted on the frame side and a lock component to be mounted on the leaf side, wherein one or both of the lock components is or are formed as (a) structural unit(s) which is or are formed separately from the components of the main drive and/or auxiliary drive or is or are formed as (a) common or connected structural unit(s) with the components of the main drive and/or auxiliary drive.

It can preferably be provided that the electrically switchable lock comprises an electrically switchable lock component and a mechanical counter component, wherein one of the lock components is to be mounted on the frame side and the other lock component is to be mounted on the leaf side.

With regard to the design and mounting arrangement of the components to be mounted on the frame side in connection with the lock, embodiments are particularly preferred which provide that the lock component to be mounted on the frame side is formed such that it can be mounted adjacent to and/or adjoining the drive assembly of the auxiliary drive to be mounted on the frame side or the part of the force-transmitting mechanism of the auxiliary drive to be mounted on the frame side.

With regard to the design and mounting arrangement of the components to be mounted on the leaf side, it can preferably be provided that the lock component to be mounted on the leaf side is formed such that it can be mounted adjacent to and/or adjoining the drive assembly of the auxiliary drive to be mounted on the leaf side or the part of the force-transmitting mechanism of the auxiliary drive to be mounted on the leaf side.

The embodiments of the drive mechanism with electrically switchable lock are possible as embodiments mounted overlying, but embodiments mounted internally are also possible. In the case of the internal embodiments, all of the leaf-side components of the main drive, of the auxiliary drive and of the lock can preferably be mounted internally in the leaf and preferably also all of the frame-side components of the main drive, of the auxiliary drive and of the lock can be mounted internally in the frame.

Particular mounting advantages with respect to simple mountability and universal mountability on different standard doors and non-standard doors result with embodiments which provide that the lock component to be mounted on the door leaf side and the components of the main drive and of the auxiliary drive to be mounted on the door leaf side are borne in or on the common and/or continuous housing mechanism and/or bearing framework mechanism and/or mounting plate mechanism to be mounted on the door leaf side and/or are covered by the common and/or continuous cover to be mounted on the door leaf side.

It can correspondingly advantageously also be provided that the lock component to be mounted on the frame side and the components of the main drive and of the auxiliary drive to be mounted on the frame side are borne in or on the common and/or continuous housing mechanism and/or bearing framework mechanism and/or mounting plate mechanism to be mounted on the frame side and/or are covered by the common and/or continuous cover to be mounted on the frame side.

Preferred embodiments provide, for the auxiliary drive, that the force-transmitting mechanism of the auxiliary drive has a rod system formed as a slide arm or scissor arm and a rod system bearing interacting with the rod system, wherein the rod system bearing is formed as a slide rail or hinge bearing and wherein the force-transmitting mechanism can be coupled in and out automatically with the drive assembly of the auxiliary drive during the opening and closing process, by forming the coupling-in/out point between the rod system and the rod system bearing, or by forming the coupling-in/out point between the rod system and the drive assembly of the auxiliary drive.

A particularly good functionality results with embodiments which provide that the rod system which is formed, at its end facing the rod system bearing, to be coupled in/out with the rod system bearing is arranged in the position coupled out of the rod system bearing and/or, during the coupling out of the rod system bearing and/or during the coupling into the rod system bearing, in a predetermined angular position relative to the drive assembly of the auxiliary drive.

Likewise good functionality results with alternative embodiments which provide that the rod system which is formed, at its end facing the drive assembly of the auxiliary drive, to be coupled in/out with the drive assembly is arranged in the position coupled out of the drive assembly and/or during the coupling-out from the drive assembly and/or during the coupling-in on the drive assembly in a predetermined angular position relative to the assigned rod system bearing.

Further developments are particularly preferred which provide that the angular position of the rod system relative to the drive assembly and/or rod system bearing of the auxiliary drive is the same during coupling-out as during coupling-in and/or is the same in the coupled-out position as during coupling-in and/or during coupling-out.

This applies correspondingly to further developments of embodiments with a scissor arm, which provide that the slide arm and/or the scissor arm is formed such that it adopts a locked angular position and/or dead center position during coupling-in and/or during coupling-out and/or in the coupled-out position.

In particularly preferred embodiments it can be provided that the rod system bearing of the auxiliary drive, which, as explained, is formed as a slide rail formed for the coupling-in/out or as a hinge bearing formed for the coupling-in/out, is supported on a component of the main drive mounted adjacent to it, namely likewise on the frame side or likewise on the leaf side. This component can be the drive assembly of the main drive or the rod system bearing of the main drive.

The support on the drive assembly of the main drive can be a support on any part of the drive assembly of the main drive or on a part supported thereon, i.e. for example a housing of the drive assembly, a bearing framework of the drive assembly or a mounting plate of the drive assembly. It is important here that the support is effected on a part of the drive assembly of the main drive which is rigidly and immovably connected to the drive assembly and thus is capable of absorbing bearing forces of the rod system bearing of the auxiliary drive supported thereon. The support on the drive assembly of the main drive can also be effected in that the rod system bearing of the auxiliary drive is supported on an output member of the drive assembly of the main drive, for example on the rod system connected to the output member of the drive assembly of the main drive. Embodiments preferably come into consideration here in which the rod system bearing of the auxiliary drive to be supported is formed as a hinge bearing, i.e. embodiments in which the free end of the scissor arm is borne on the rod system of the main drive.

It can, as stated, also be provided that the rod system bearing of the auxiliary drive is supported on the rod system bearing of the main drive. The rod system bearing of the main drive can be formed, depending on the design of the rod system of the main drive, as a slide rail in the preferably linear slide rail guide track of which the free end of the rod system formed as a single- or multi-component slide arm is guided movably, with simultaneous pivoting of the slide arm. The rod system bearing of the main drive can, however, also be formed as purely a hinge bearing, on which the rod system of the main drive formed as a scissor arm is borne pivotably with its free end. In the case of these solutions, it is important that the rod system bearing of the auxiliary output is supported on the rod system bearing of the main drive, i.e. is preferably rigidly and immovably connected to the rod system bearing of the main drive, with the result that the bearing forces of the rod system bearing of the auxiliary drive can be introduced into the bearing mounted adjacent to it.

With the introduction of force of the rod system bearing of the auxiliary drive into the adjacent, preferably adjoiningly mounted component of the main drive, it is unnecessary to form separate bearings and support mechanisms of the rod system bearing of the auxiliary drive on the leaf or on the frame with corresponding separate fastening points or, if such things are additionally present, they are unloaded by the at least partial introduction of force into the rod system bearing of the auxiliary drive. Embodiments are also possible in which exclusively the rod system bearing of the auxiliary drive is mounted on the leaf or in the frame via corresponding fastening points and the adjoining component of the main drive is supported thereon in a force-introducing manner. In the case of the solution according to the invention, it is important that the rod system bearing of the auxiliary drive is realized with the adjoining components in question a common support on the leaf or on the frame.

In preferred embodiments it can also be provided that the drive assembly of the auxiliary drive is borne in a fastening bearing which is supported on a component of the main drive mounted adjacent to it, namely likewise on the leaf side or likewise on the frame side. The adjacent component of the main drive can be the drive assembly of the main drive, namely a bearing framework or a part rigidly connected thereto and/or a bearing plate or a part rigidly connected thereto and/or a receiver housing or a part rigidly connected thereto of the drive assembly of the main drive or it can be the rod system bearing of the main drive, namely a bearing framework or a part rigidly connected thereto and/or a bearing plate or a part rigidly connected thereto and/or a receiver housing or a part rigidly connected thereto of the rod system bearing of the main drive formed as a slide rail or hinge bearing. It is important in each case that the bearing forces of the fastening bearing, in which the drive assembly of the auxiliary drive is borne, are introduced into the bearing of the adjoiningly mounted component of the main drive in question. In this way, separate fastening points for the mounting of the fastening bearing of the drive assembly of the auxiliary drive on the leaf or on the frame are unnecessary. Otherwise, additional separate fastening points of the fastening bearing are present and the introduction of force into this separate bearing and into the bearing of the adjacent component of the main drive is distributed and thus the separate fastening points are partially unloaded.

Embodiments are possible in which the fastening bearing of the drive assembly of the auxiliary drive is formed as a hinge bearing. However, embodiments are also possible in which the fastening bearing is formed as a fixed bearing.

In further preferred embodiments, it can be provided that the force-transmitting rod system of the main drive is formed as a rod system with a slide rail with a horizontal guide rail track and a slide arm guided therein, wherein the slide arm is formed as a special angular arm.

The angular arm has a first segment and a second segment, which are arranged angled relative to each other, forming an angular corner.

The end of the first segment of the angular arm is borne in a first hinge bearing, which is supported on a fastening surface which can be or is stationarily and/or rigidly connected to the support of the drive assembly of the auxiliary drive. This means that the angular arm has a hinge bearing which in the case of leaf-side support or leaf-side mounting of the drive assembly of the auxiliary drive is likewise supported on the leaf side or mounted on the leaf side.

The free end of the second segment of the angular arm is guided so that it can be coupled into/out of the horizontal guide rail track of the slide rail of the auxiliary drive during the closing and opening process.

A connecting section for connecting the output of the drive assembly of the auxiliary drive is formed in the vertex area of the angular corner of the angular arm. Alternatively, such a connecting section for connecting the output of the drive assembly of the auxiliary drive can also be formed on the first segment or on the second segment or on an extension of the first or second segment.

The angular arm thus forms a special slide arm which is guided with its free end in the slide rail and is supported with its other end in a hinge bearing which is supported on the leaf side in the case of a leaf-side mounting of the drive assembly of the auxiliary drive and is supported on the frame side in the case of a frame-side mounting of the drive assembly of the auxiliary drive. This angular arm is additionally acted on by the output member of the drive assembly of the auxiliary drive and thus forms a configuration of the toggle lever type. It is important here that the free end of the angular arm, which is guided so that it can be coupled into and out of the slide rail, can be forcibly coupled in during the closing process at the predetermined opening angle of the door and can be forcibly coupled out during the opening process at a specific opening angle of the door.

The angular arm with the output of the drive assembly of the auxiliary drive supported on the angular arm forms a configuration of the toggle lever type. The angular arm can form a dead center position in which the angular arm is formed protruding in a fixed angular position. The dead center position guarantees a secure coupling of the angular arm into and out of the assigned slide arm.

With regard to preferred embodiments of the drive mechanisms composed of main drive and auxiliary drive, with respect to the design of the drive assemblies, the following applies:

With regard to the drive assembly of the main drive:

The drive assembly of the main drive can be formed as a spring brake, which is forcibly loaded during the opening process and then drives the door to close when being unloaded. However, embodiments are also possible in which the drive assembly is formed as a spring brake which is loaded during closing and then drives the door to open when being unloaded.

The drive assembly can have a damper, preferably a hydraulic damper, to damp the closing movement and/or the opening movement. The loading of the spring brake can be forcibly effected both in the case of the closing drive and in the case of the opening drive during manual operation of the door, i.e. can be forcibly effected during the opening process in the case of the closing drive and can be forcibly effected during the closing process in the case of the opening drive. However, an electric motor can also be provided for loading the spring brake and embodiments are also possible in which a preferably electrically switchable locking mechanism is provided with which the spring brake is held in the loaded state in order to be switched on to close or to open during corresponding switching of the locking mechanism during the closing process and/or during the opening process or in order to act as an emergency closer or emergency opener. The locking mechanism can also be formed mechanically switchable, e.g. also forcibly switching automatically.

Alternatively or in addition to the spring brake, the drive assembly of the main drive can also have an electromechanical motor, with which the opening process and/or the closing process is effected by means of an electric motor.

With regard to the drive assembly of the auxiliary drive:

The drive assembly of the auxiliary drive can be formed as a spring brake which is forcibly loaded during the opening process and then drives the door to close when being unloaded. However, embodiments are also possible in which the spring brake is loaded during the closing and then drives the door to open when being unloaded.

The drive assembly can have a damper, preferably a hydraulic damper, to damp the closing movement and/or the opening movement.

The loading of the spring brake can be forcibly effected during manual operation of the door, i.e. during opening or during closing. However, an electric motor can also be provided for the electromechanical loading of the spring brake.

Embodiments are also possible in which a preferably electrically switchable locking mechanism is provided with which the spring brake is held in the loaded state in order to be switched on to close or to open during corresponding switching of the locking mechanism during the closing process and/or during the opening process or in order to act as an emergency closer or emergency opener. The locking mechanism can also be formed mechanically switchable, e.g. also forcibly switching automatically for instance in connection with the coupling-in/out of the rod system or when a specific door opening angle is reached.

Alternatively or in addition to the spring brake, the drive assembly can also have an electromechanical motor, with which the opening process and/or the closing process is effected by means of an electric motor.

The auxiliary drive is provided to supplement the main drive. The auxiliary drive and the main drive are advantageously formed as separate drive mechanisms which interact in combination with each other. They are preferably mounted next to each other on the door. The components of the auxiliary drive and main drive are preferably separate structural units, but can be connected to each other, e.g. by mutual fastening and/or connection points and/or by common bearing mechanisms or cover mechanisms.

The drive mechanism of the auxiliary drive is composed of a drive assembly and a force-transmitting mechanism. The drive unit of the main drive is likewise composed of a drive assembly and a force-transmitting mechanism.

Important advantages result if the auxiliary drive is formed such that the force-transmitting mechanism has a coupling-in/out point, with the result that it is possible to switch on the auxiliary drive only in a specific door opening range during the closing process and/or during the opening process, in order to assist the main drive only in this specific range.

With regard to the force-transmitting mechanism:

Each drive assembly is assigned a force-transmitting mechanism in the preferred embodiments of the drive mechanism according to the invention. The force-transmitting mechanism can be composed of a rod system and a rod system bearing. The rod system has a connecting end for connection to the output of the assigned drive assembly. The rod system is borne in the rod system bearing at the end facing away from the drive assembly. The rod system can be formed as a slide arm or as a scissor arm. The rod system bearing can be formed as a slide rail or pivot bearing. The rod system forms the force-transmitting connection of the force-transmitting mechanism. It connects the output of the drive assembly to the rod system bearing in a force-transmitting manner.

It may be pointed out that the rod system can have another further support in addition to the connecting end of the rod system which can be connected to the output of the drive assembly. This further support can be the support in a bearing which is formed stationary with the support of the drive assembly. For example such embodiments are possible in the case of a slide arm which engages with its connecting end on a linear output of the drive assembly and has a further connecting end protruding at an angle, in order to be supported in a bearing which is stationary with a bearing in which the drive assembly is supported.

The force-transmitting mechanism serves to transmit the drive forces between the door leaf and the frame. If the drive assembly is mounted on the leaf, the rod system bearing is to be mounted on the frame. If the drive assembly is mounted on the frame, the rod system bearing is to be mounted on the leaf. The mounting arrangement on the frame and leaf can be chosen to be the same for the main drive as for the auxiliary drive. The arrangement can be such that the drive assemblies are both mounted on the leaf and the rod system bearings are both mounted on the frame or vice versa, that the drive assemblies are both mounted on the frame and the rod system bearings are both mounted on the leaf. The arrangements can, however, also be chosen different from each other, i.e. the drive assembly of the auxiliary drive on the leaf and the drive assembly of the main drive on the frame and the rod system bearing of the auxiliary drive on the frame and the rod system bearing of the main drive on the leaf or vice versa, namely the drive assembly of the auxiliary drive on the frame and the drive assembly of the main drive on the leaf and the rod system bearing of the auxiliary drive on the leaf and the rod system bearing of the main drive on the frame.

With regard to the terms slide arm and slide rail, it may be pointed out that the free end of the slide arm is guided in the slide rail and need not necessarily slide in the physical sense. In each case, however, the slide rail has a guide track in which the free end of the slide arm is guided. The free end can be formed as a slide block which is guided actually sliding in the physical sense in the guide track. The slide can, however, also be a roller which is guided rolling in the guide track of the slide rail. The slide can also be a pinion which is guided meshing with teeth or the like in the guide track of the slide rail. By slide is thus not necessarily meant a slide element which slides in the physical sense.

The slide arm, however, is always a force-transmitting guide arm and the slide rail is always a guide rail, wherein the guide arm is guided with its free end in the guide track of the guide rail.

The guide track of the guide rail can be a linear guide track. However, embodiments in which the guide track is formed as a non-linear curved track are also possible.

The invention is explained in more detail below with reference to figures. There are shown in:

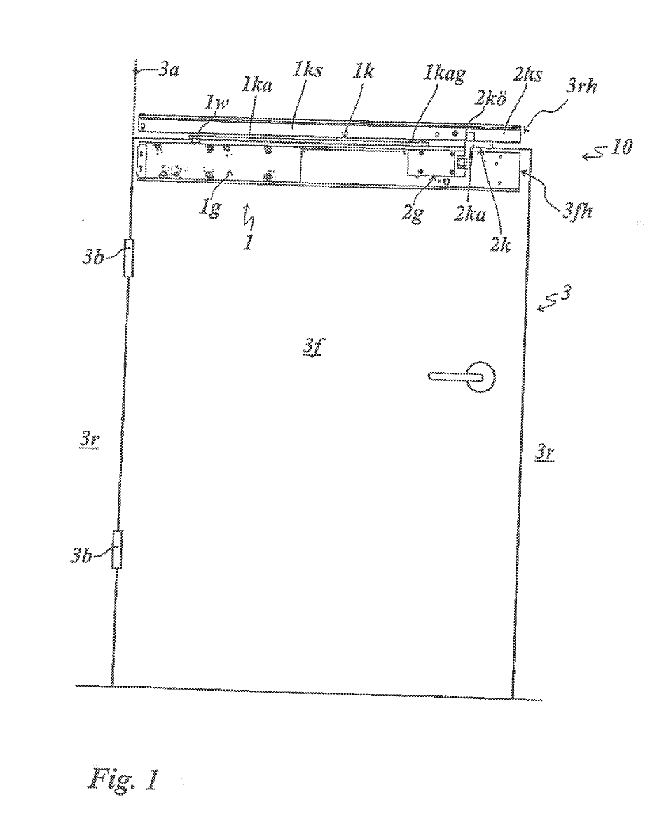

FIG. 1 a front view of a door with an embodiment example of the door drive mechanism according to the invention consisting of a main drive 1, which is formed as a slide arm door closer, and an auxiliary drive 2, which is formed as a door shutting device and/or damper; in the closed position of the door;

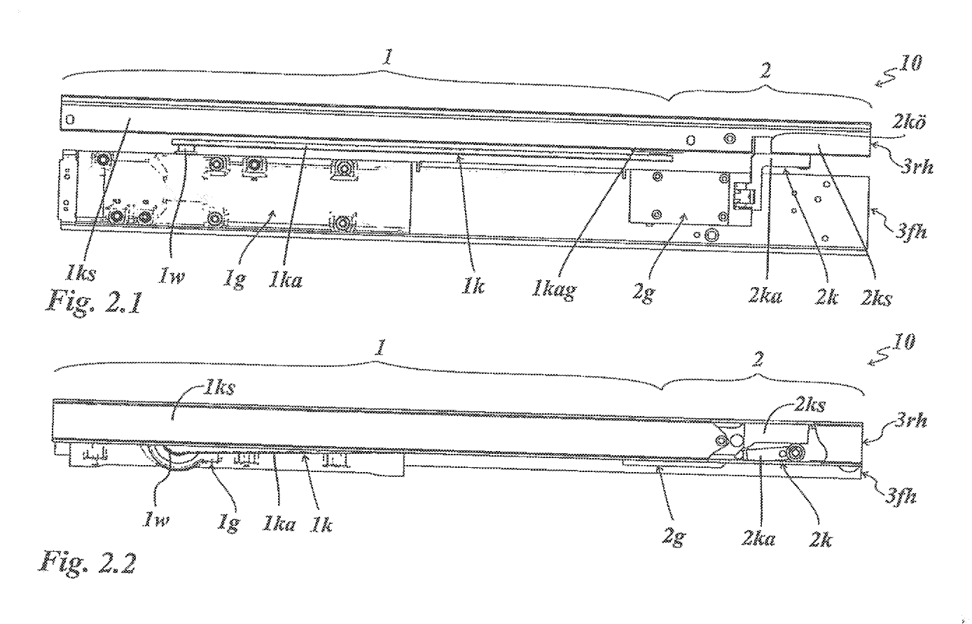

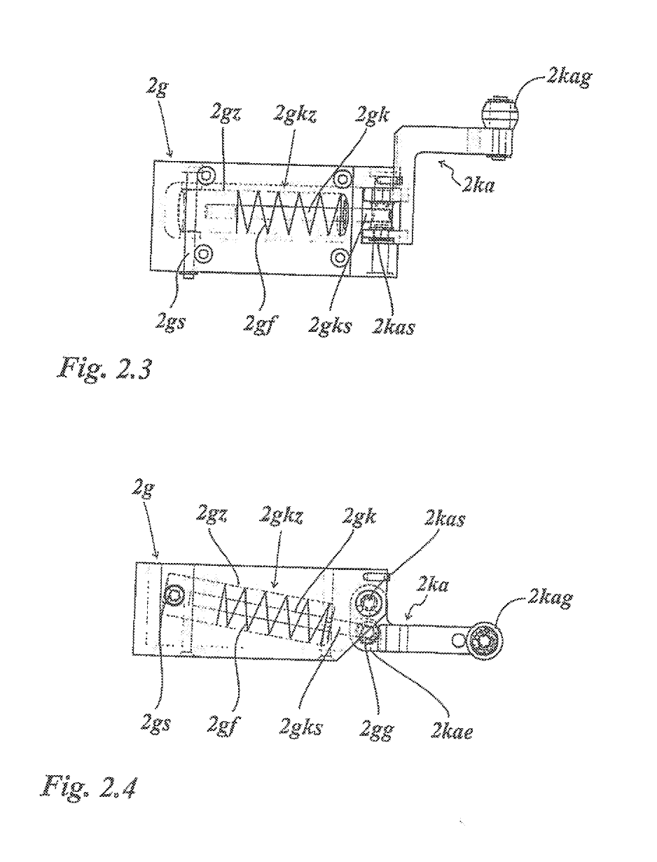

FIG. 2.1 a section in FIG. 1, showing only the door drive mechanism consisting of the main drive 1 and the auxiliary drive 2;

FIG. 2.2 a top view in FIG. 2.1. from above;

FIG. 2.3 a detail representation of the auxiliary drive 2 in the front view representation in FIG. 2.1 without slide rail

FIG. 2.4 a detail representation of the auxiliary drive 2 in the top view representation in FIG. 2.2;

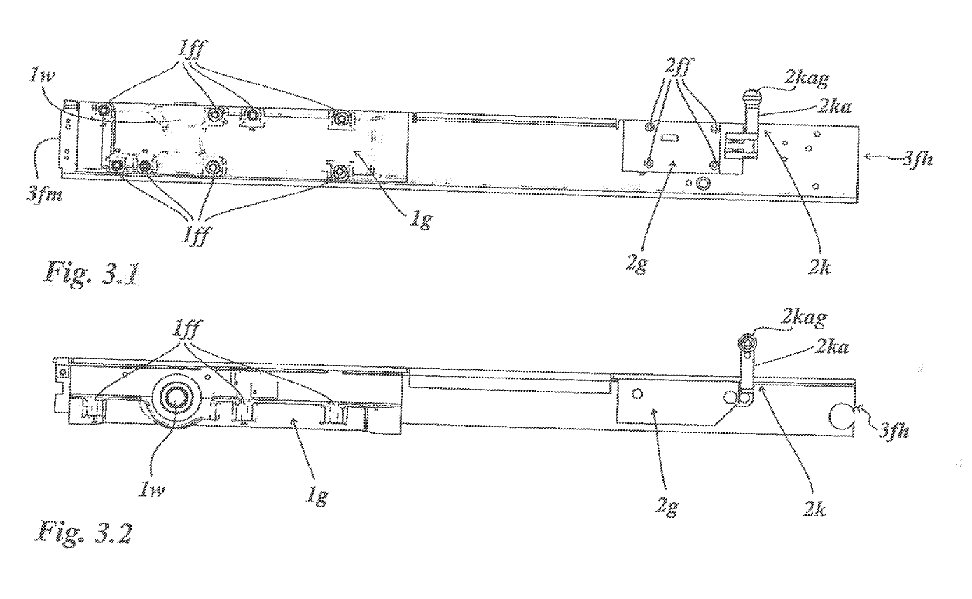

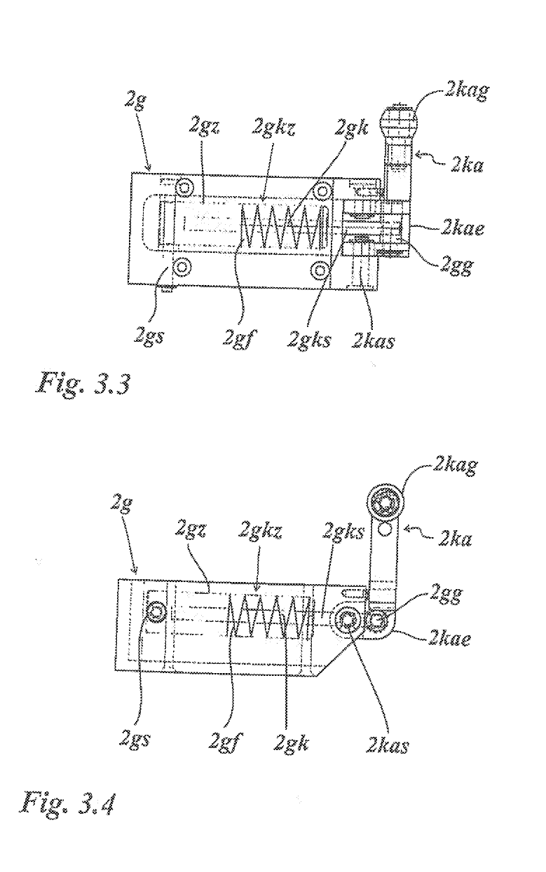

FIG. 3.1 a section representation corresponding to FIG. 2.1, but without slide rail and with an at least partially opened door and slide arm of the auxiliary drive 2 coupled out of the slide rail;

FIG. 3.2 a top view in FIG. 3.1;

FIG. 3.3 a detail representation of the auxiliary drive 2 in the front view representation in FIG. 3.1;

FIG. 3.4 a detail representation of the auxiliary drive 2 in the top view representation in FIG. 3.2;

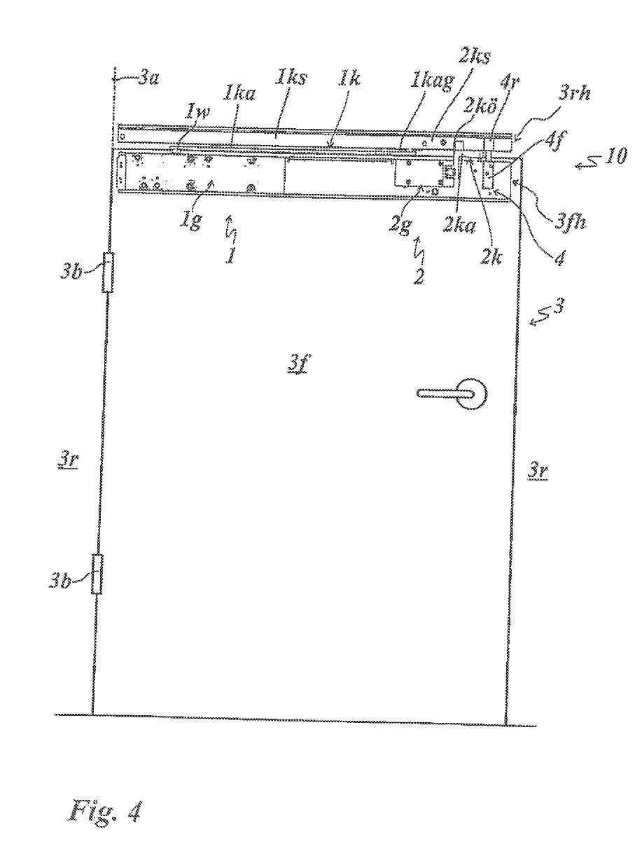

FIG. 4 a representation of the door corresponding to FIG. 1 with a second embodiment example of the door drive mechanism according to the invention, in which an electrically switchable lock 4 is additionally mounted on the door;

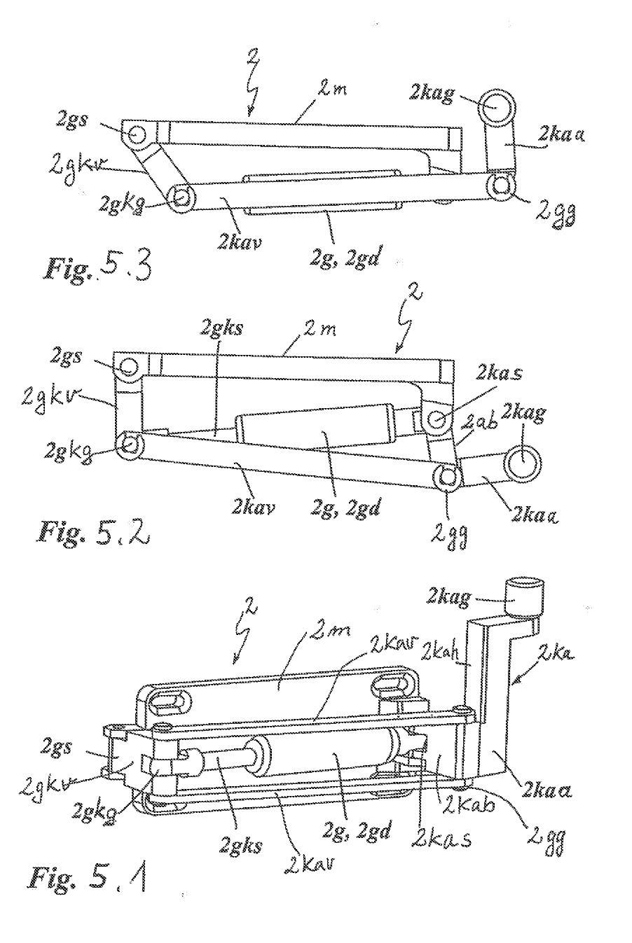

FIG. 5.1 a detail representation of the auxiliary drive, modified compared with the embodiment in the preceding figures, in perspective representation in the closed position of the door;

FIG. 5.2 a top view in FIG. 5.1;

FIG. 5.3 a representation corresponding to FIG. 5.2, but in the open position of the door;

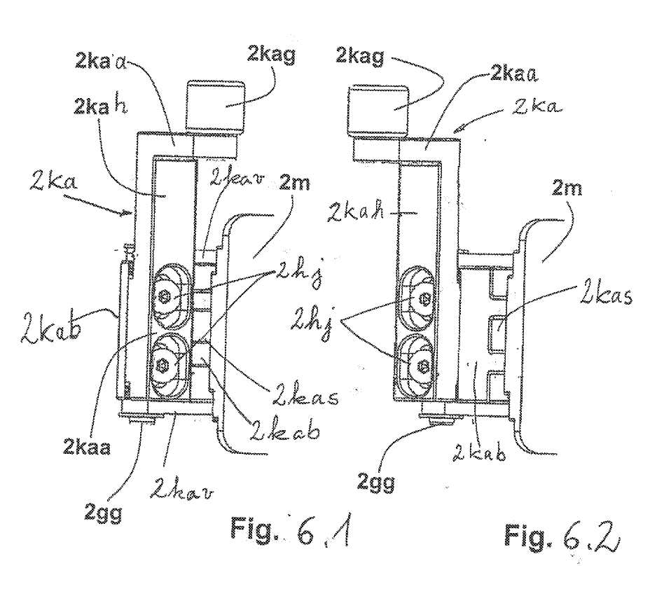

FIG. 6.1 a section representation of the angular arm in a modified embodiment of the auxiliary drive of FIGS. 5.1 to 5.3;

FIG. 6.2 a representation corresponding to FIG. 6.1 of the auxiliary drive in another angular position of the angular arm;

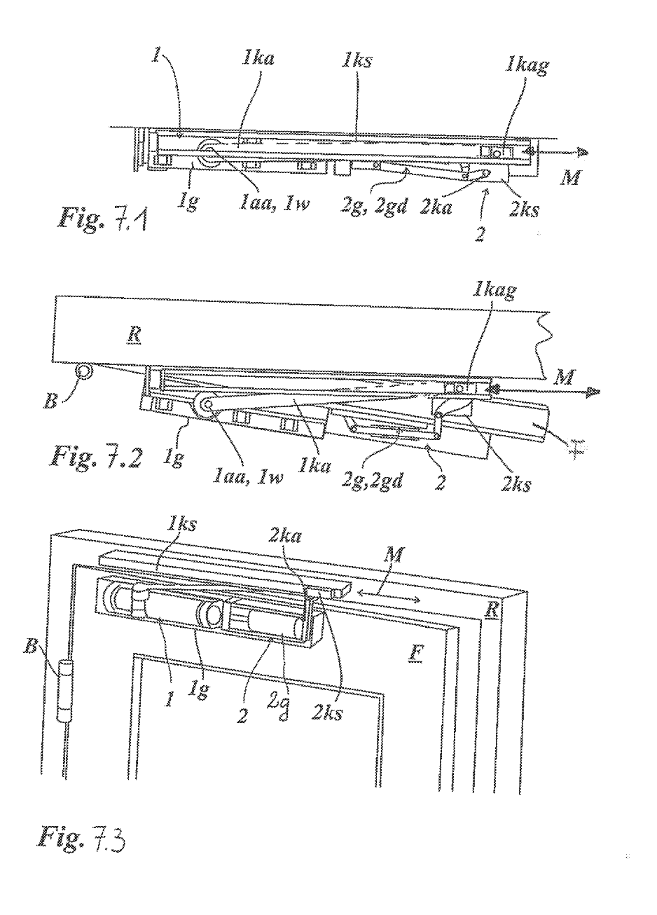

FIG. 7.1 a top view of a further embodiment example of a drive mechanism with main drive and auxiliary drive, in the closed position of the door;

FIG. 7.2 a representation corresponding to FIG. 7.1 of the drive in FIG. 7.1, but in the open position of the door shortly before the closed position during the coupling-out of the angular arm of the auxiliary drive;

FIG. 7.3 a perspective front view of the drive in FIGS. 7.1 and 7.2;

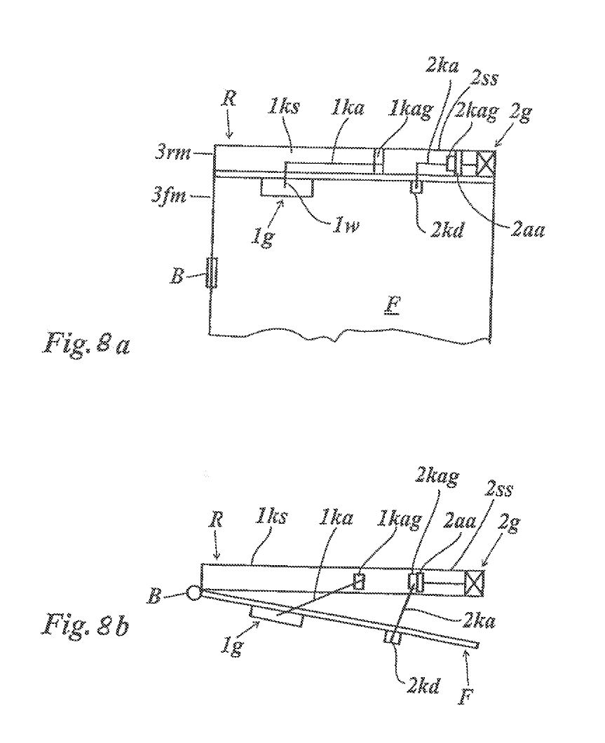

FIGS. 8a, b, c: schematic representations of an embodiment example of a door drive according to the invention in different door positions:

FIG. 8a: front view in the closed position of the door;

FIG. 8b: top view in the opening position of the door at a 20° door opening angle;

FIG. 8c: top view in the open position of the door at a 90° door opening angle with coupled-out slide arm of the auxiliary drive, wherein the coupling point is formed between the output of the drive assembly and the connecting end of the slide arm;

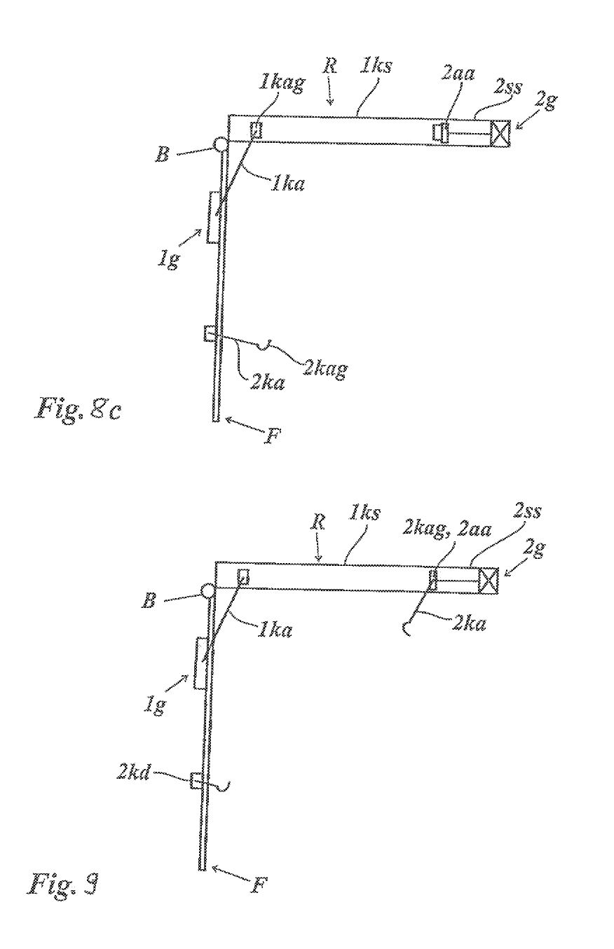

FIG. 9: a representation corresponding to FIG. 8c of a modified embodiment example, in which the slide arm of the auxiliary drive is coupled out, but the coupling-out point is formed on the leaf-side pivot bearing of the slide arm.

The embodiment example represented in the figures is a door drive mechanism which is formed in the specific case as a manual door closer mechanism, i.e. with a closing spring brake without a motorized drive operable with external energy. The door closer mechanism represented is composed of a main drive 1 formed as a slide arm door closer and an auxiliary drive 2 which can be formed as a door shutting device and/or closing damper. This division into main drive 1 and auxiliary drive 2 is important, i.e. it is important that the door closer mechanism is composed of a main drive 1 and an auxiliary drive 2. This composite door drive mechanism is given the reference number 10 in the figures and is mounted on a door 3 in FIG. 1. The door 3 is, as FIG. 1 shows, a swing door, which comprises a door leaf 3f which is borne pivotably about a vertical door axis 3a via door hinges 3b in a stationary door frame 3r. The door leaf 3f is formed as a stop swing leaf in the case represented. The door drive mechanism is formed as a mechanism mounted overlying the door in the case represented. However, it may expressly be pointed out that the door drive mechanism 10 of this structure can also be designed as a door drive mechanism to be mounted internally concealed in the door.

### The Main Drive:

As the figures show, the slide arm door closer forming the main drive 1 comprises a drive assembly 1g, which is formed as a door closer assembly accommodated in a door closer housing 1g and a force-transmitting mechanism 1k. The force-introducing mechanism 1k consists of a rod system, which is formed as a slide arm 1ka, and a rod system bearing, which is formed as a slide rail 1ks. This force-transmitting mechanism 1k constructed in such a way is in practice also called a force-transmitting slide rail rod system. The door closer housing 1g is mounted on the door leaf 3f in the case represented. The closer mechanism is accommodated in the door closer housing 1g. It is not represented in more detail in the figures. It can, as is conventional, comprise a closer spring mechanism and a damper. The damper is preferably formed as a hydraulic damper. Via the damper, the closing speed and the opening speed of the door can preferably be adjusted via flow control valves. The closer spring mechanism and the damper are actively connected to a door closer shaft 1w. The door closer shaft 1 is borne rotatably in the door closer housing 1g. The slide arm 1ka of the rod system 1k is connected to the end of the door closer shaft 1w protruding from the housing. This rod system consists of the slide arm 1ka and the slide rail 1ks in the case represented. The slide arm 1ka is a one-armed lever, which is connected with its end facing the output of the drive assembly 1g, i.e. the door closer shaft 1w, to this in a rotationally fixed manner. This end of the slide arm 1ka forms the connecting end. With its other end, the slide arm 1ka is guided in the slide rail 1ks via a slide 1ka g engaging in the guide track of the rail. The slide rail 1ks is mounted horizontally aligned on the upper horizontal beam of the stationary door frame 3r securely on the door frame. The slide arm door closer 1 in the case represented is, as already mentioned, formed as an overlying slide arm door closer, i.e. the door closer housing 1g and the slide rail 1ks are in each case mounted overlying. In the case represented, the door closer housing 1g is mounted overlying the door leaf 3f in the upper area of the door leaf and the slide rail 1ks is mounted overlying on the upper horizontal beam of the door frame 1r.

### The Auxiliary Drive

The auxiliary drive 2 in the case represented is formed as a door shutting device with damping. It is a drive unit which is formed separately from the slide arm door closer 1 forming the main drive 1. It comprises, as drive assembly 2g, a damped shutting assembly, which is mounted overlying the door leaf 3f, namely away from the door axis relative to the main drive 1, i.e. further removed from the door axis than the door closer housing 1g of the main drive 1, namely mounted at a distance next to the door closer housing 1g in the upper area of the door leaf. The shutting assembly 2g, as stated, forms the drive assembly of the auxiliary drive 2. The assembly 2g is formed as a spring brake with a hydraulic damper. In the case represented, it comprises a piston-cylinder unit 2gkz, which interacts with a closer spring mechanism 2gf. Reference may be made to FIGS. 2.3 and 2.4 and to FIGS. 3.3 and 3.4. The piston-cylinder unit 2gkz represented can be formed as a hydraulic damper. Instead of the represented piston-cylinder unit 2gkz with closer spring 2gf, however, a pneumatic spring can also be provided. The cylinder 2gz of the piston-cylinder unit in the case represented is borne pivotably on the door leaf 3f in a pivot bearing 2gs mounted securely on the door leaf with a pivot axis that is vertical in the installed position. The piston 2gk is linearly movable in the cylinder. The piston 2gk is formed as a piston rod 2gks in the area of its free end section. The free end of the piston rod 2gks forms the output end of the piston rod and thus the output end of the drive assembly 2g of the auxiliary drive 2.

The force-transmitting mechanism 2k of the auxiliary drive 2 in the case represented is formed as a slide rail rod system, which is composed of an angular arm 2ka as slide arm and a slide rail 2ks as rod system bearing. The angular arm 2ka is formed as a slide arm that can be coupled in/out vis-à-vis the slide rail. The angular lever 2ka is connected via a connecting hinge 2gg to the output end of the piston rod 2gks of the auxiliary drive 2. The hinge axis of the connecting hinge 2gg is aligned vertically in the installed position, i.e. parallel to the pivot axis of the pivot bearing 2gs, via which the drive assembly 2g of the auxiliary drive 2 is mounted on the door leaf. The angular lever 2ka in the case represented is formed as a right angle. The connecting hinge 2gg at the output end of the piston rod 2gks engages at the outer vertex corner point of the angular lever 2ka. The angular lever 2ka has a shorter segment and a longer segment. At the free end of the shorter segment, the angular lever 2ka is borne pivotably in a pivot bearing 2kas with vertical pivot axis. The pivot bearing 2kas is mounted securely on the leaf in the same way as the pivot bearing 2gs of the cylinder 2gz. Both bearings 2kas and 2gs are mounted in a bearing framework in rigid mutual assignment. The pivot bearing 2kas forms an output bearing that is stationary with the drive assembly. The connection of the angular arm 2ka in the area of its angular vertex corner 2kae at the output end of the piston rod 2gks, forming the connecting hinge 2gg, forms the connection of the angular lever 2ka at the output end of the drive assembly 2g.

The free end of the long segment of the angular lever 2ka is formed as a slide 2kag and can be automatically coupled into and out of the slide rail 2ks of the door shutting device 2 mounted on the frame side. In the position coupled into the slide rail 2ks, the angular lever 2ka with the slide rail 2ks forms a force-transmitting rod system as a special slide arm rod system with slide rail. The automatic coupling-in and -out is effected when the door leaf reaches a predetermined door opening angle. This predetermined door opening angle is an approx. 30° door opening angle in the embodiment example represented. During the opening process and during the closing process in the range of the door opening angles between 30° and 0°, i.e. in the partial opening range between a door opening of 30° and the closed position of the door, the angular lever 2ka is guided as a force-transmitting slide arm with its slide 2kag engaging in the slide rail 2ks.

As can best be seen from the representation in FIGS. 2.3 and 2.4 as well as FIGS. 3.3 and 3.4, the pivotably borne piston-cylinder unit 2gkz with its piston rod 2gks together with the likewise pivotably borne angular lever 2ka in conjunction with the hinge connection in 2gg forms a toggle lever. The connecting hinge 2gg forms the hinged joint. Because of this hinged joint configuration, the angular lever 2ka can adopt two dead center positions. One dead center position is the coupling-in/out position which is shown in FIGS. 3.3 and 3.4. In this position, the hinge points of the bearings 2gs, 2kas, 2gg lie in a line. The other dead center position of the angular lever 2ka is the closing end position in which the angular lever is coupled into the slide rail 2ks and adopts its end position on the right in FIG. 1, in which the door is closed. This dead center position is shown in FIGS. 2.3 and 2.4. In this position, the hinge points of the bearings 2gs, 2gg, 2kag lie in a line. The hinge point 2kag is formed by the slide of the slide arm 2ka engaging in the slide rail 2ks in this position. In both dead center positions, the slide arm 2ka is constantly locked in the assigned angular position and thus the output of the connected drive assembly 2g is also correspondingly fixed.

The closing spring 2gf of the piston-cylinder unit 2gkz is more strongly tensioned in the first dead center position, i.e. in the coupling-in/out position of the slide arm 2ka, than in the second dead center position, i.e. in the end position which is assigned to the closed position of the door. In the coupled-out position, the tension of the closer spring, i.e. the loading which the closer spring adopts in the coupling-in/out position, is maintained by the first dead center position of the slide arm 2ka.

As soon as the slide arm 2ga is coupled into the slide rail 2ks, the first dead center position is automatically released during the closing process and the slide arm 2ka is driven by the action of the closing spring 2gf in the closing direction, reducing the pretension of the closing spring 2gf. The slide arm 2ga rotates clockwise in FIG. 3.2 and runs towards the right in the slide rail 2ks in FIG. 1. During the opening process, the movement of the slide arm 2ka is exactly reversed. In a corresponding manner, the closing spring 2gf is loaded during the opening movement of the door as long as the slide arm 2ga is guided coupled into the slide rail 2ks.

In the embodiment example represented, it is important that the slide arm door closer 1 is arranged closer to the door axis, i.e. closer to the door hinges, than the auxiliary drive 2. During the entire opening and closing process, the slide arm 1ka of the slide arm door closer 1 remains permanently coupled with the slide rail 1ks and guided therein. The slide at the free end of the slide arm 1ka runs in the slide rail 1ks towards the right in FIG. 1 during closing and towards the left in FIG. 1 during opening. In contrast, the force-transmitting rod system 2k of the auxiliary drive 2 is, as already explained above, formed such that the slide arm 2ka can be automatically coupled into and out of the slide rail 2ks at a predetermined door opening angle during the closing and opening process. The coupling-in and -out is effected in such a way that the angular lever acting as slide arm 2ka is coupled with the slide rail 2ks with its free end exclusively at door opening angles in the range between this predetermined door opening angle and the closed position, i.e. engages in the slide rail in this door opening angle range and is guided in the slide rail 1ks only in this angle range during the closing process and during the opening process. In the range of larger door opening angles, i.e. starting from the predetermined door opening angle, the slide arm 2ka is coupled out of the slide rail 2ks with its free end, i.e. is not connected to the slide rail and is not guided in the slide rail.

The slide rail 2ks has an opening 2kö on the front side, to couple the slide 2kag formed at the free end of the slide arm 2ka in and out. Via a running-in slope, this opening opens into a slide track inside the slide rail 2ks in which the slide 2kag is guided after the coupling-in during the closing movement and the return movement in the opening direction. This slide track in the horizontally mounted slide rail 2ks can be formed linear or non-linear depending on the embodiment variant of the auxiliary drive 2. The coupling-in and -out of the slide arm 2ks is effected, as explained, automatically during the opening and closing process.

### The External Covering of the Components of the Drive Mechanism Mounted on the Leaf Side and on the Frame Side:

An important advantage results in the embodiment example represented from the fact that, as shown in FIG. 1, all of the components of the drive mechanism mounted on the door leaf side, i.e. the door closer housing 1g and the drive assembly 2g of the auxiliary drive 2, are covered by a common cover housing 3fh and all of the components of the drive mechanism mounted on the door frame side, i.e. the slide rail 1ks of the door closer and the slide rail 2ks of the door shutting device, are covered by a common cover housing 3rh. These cover housings 3fh, 3rh can in each case be formed as a U-shaped profile. It is substantially advantageous that they are formed with a cross section that is constant over their longitudinal extent. They are preferably formed such that they extend in each case over the entire width of the leaf, have an identical longitudinal extent and can be mounted flush with each other on the end side. The cover housings 3fh, 3rh can in each case be formed in one piece, but it is also possible to form them from several partial sections over the longitudinal extent. The common covers 3rh and 3fh are in each case formed continuously over the entire door width, which brings visual advantages.

### The Mounting of the Leaf-Side and of the Frame-Side Components on a Common Leaf-Side and Frame-Side Mounting Plate Respectively

In the case represented, it is also advantageous to mount the components to be mounted securely on the door leaf on a common mounting plate 3fm, which is preferably mounted in a standard drill-hole pattern of the door leaf. This applies correspondingly to the mounting of the components to be mounted securely on the door frame on a common mounting plate 3fm, which is mounted on the door frame side (see FIG. 1).

The mounting of the mounting plate 3fm to be mounted on the leaf side in a standard drill-hole pattern of the door leaf means that the fastening of the mounting plate 3fm on the leaf is effected via a fastening hole pattern which is formed in the section of the mounting plate close to the hinge. In FIG. 1 this fastening hole pattern is in the left-hand section of the mounting plate 3fm, in which the drive assembly of the main drive 1, i.e. the door closer housing 1g of the slide arm door closer, is mounted. In the section of the mounting plate away from the hinge, in which the drive assembly of the auxiliary drive 2, i.e. the drive assembly 2g, is mounted, the mounting plate 3fm is not screwed to the leaf, as no standard hole pattern is provided in this area of the leaf.

In the case of the embodiment to be mounted internally concealed in the door, the components can be mountable separately internally in corresponding separate or continuous recesses in the leaf and in the frame. However, mounting embodiments are also possible in which the leaf-side components are mounted internally on a common mounting plate and the frame-side components are mounted internally on a common mounting plate. The components mounted on the common mounting plate in this case form a previously mounted structural unit which can be mounted recessed into a corresponding receiver recess in the leaf.

### The Mode of Operation of the Drive Mechanism:

The mode of operation of the door closer mechanism 10 composed of the slide arm door closer 1 and the auxiliary drive 2 is as follows:

From the closed position of the door represented in FIG. 1 the door 3 can be opened by pivoting the door leaf 3f manually in the opening direction. Here, the door closer slide arm 1ka rotates, with the door closer shaft 1w connected in a rotationally fixed manner, about the rotational axis of the door closer shaft 1w counter-clockwise in FIG. 1. The slide arm 1ka is guided with its free end formed as a slide in the slide rail 1ks in such a way that the free end of the slide arm 1ka runs towards the left in the representation in FIG. 1.

During this opening movement, the slide arm 2ka of the auxiliary drive 2 formed in the manner of a toggle lever also rotates, namely in a corresponding manner, by the free end of the slide arm 2ka with its free end in the slide rail 2ks running towards the left in the representation in the figures. The toggle lever-type slide arm rod system, which is composed of the angular arm 2ka and the piston rod 2gks of the piston-cylinder unit 2gkz, here rotates in a corresponding manner about the axis of the hinge bearing 2gs mounted securely on the leaf. In the embodiment example represented, however, it is important that this toggle lever-type rod system, i.e. the free end of the angular slide arm 2ka, is automatically coupled out of the slide rail 2ks as soon as the door opening angle predetermined for this is reached from the closed position. In the embodiment example represented, this is effected at a door opening angle of approx. 30°. In this angular position, the toggle lever-type rod system 2k reaches its first dead center position. During the coupling out of the slide rail 2ks, the angular arm 2ka remains in the angular position of this dead center position. In this position, the angular arm is virtually locked against further rotation and moves out of the front-side opening 2kö of the slide rail 2ks in this angular position during further opening of the door. In the dead center position, the angular arm 2ka remains virtually locked. The piston rod of the piston-cylinder mechanism with the closer spring likewise remains locked in this position.

If the door is to be brought from the open position back into the closed position, the closing movement is effected in the case of a coupled-out angular arm 2ka up to the predetermined coupling-in angular position. The angular arm 2ka is therefore unchanged in the dead center position of FIGS. 3.1 and 3.4, which it adopted during the coupling-out. As soon as the door leaf has now reached the predetermined door opening angle of approx. 30° during the closing process, the angular arm 2ka fixed in this coupling-in/out angular position again comes with its free end, i.e. the slide 2kag, to be coupled into the slide rail 2ks. The free end of the slide arm 2ka with the slide 2kag moves into the opening of the slide rail 2ks. During further closing of the door, the angular arm 2ka is coupled with its free end into the slide rail 2ks and in the representation in FIG. 1 runs in the slide track of the slide rail 2ks towards the right guided by the slide rail 2ks. The toggle lever configuration here has released the coupling-in/out catch position automatically, under the action of the slide rail guide. As soon as this dead center position is released, the closer spring held tensioned until then now acts, while being unloaded, as a rotary drive of the angular lever in the closing direction. In other words, the closing process is then effected aided by the auxiliary drive 2. The toggle lever finally reaches its second dead center position represented in FIG. 1 in the closed position of the door. In this second dead center position, the toggle lever configuration locks in the angular position in question. This dead center position is then maintained until the door is pivoted back into the open position by manual pulling of the door leaf. During this opening movement, the dead center position is automatically raised by the pivoting of the angular arm 2ka and the closer spring is again loaded.

The second embodiment example represented in FIG. 4 differs from the embodiment example represented in FIGS. 1 to 3 only in that in the embodiment example in FIG. 4 an electrically switchable lock 4 is additionally mounted on the door. The electrically switchable lock 4 consists of a lock component 4r mounted on the frame side and a lock component 4f mounted on the leaf side. The lock component 4r mounted on the frame side is an electrically switchable locking component, in the specific case an electrical door opener. The electrical door opener is mounted in the common rail housing in the section furthest removed from the hinge, in that the slide rail 1ks of the main drive is formed in a section close to the hinge and, adjacent thereto, the slide rail 2ks of the auxiliary drive is formed on the side of the slide rail 1ks facing away from the hinges. The electrical door opener forming the lock component 4r mounted on the frame side is conventionally constructed with a movably borne door opener latch which interacts with an electrically switchable locking mechanism, preferably with an electromagnet. The door opener latch and the electrically switchable locking mechanism with a connected gearing mechanism form the electrical door opener which, in the embodiment example represented, forms the lock component 4r mounted on the frame side.

The lock component 4f mounted on the leaf side is formed as a counter element which interacts with the frame-side lock component. The counter element is preferably formed in the manner of a spring-loaded falling latch which has a latch body with a running-in slope, which is acted on in the extending direction by a spring.

An important advantage results in the specific embodiment example in FIG. 4 from the fact that the leaf-side lock component 4f is mounted on the common mounting plate 3fm mounted securely on the leaf. On this mounting plate, the door closer housing 1g of the main drive 1 is mounted in the section close to the hinge and the drive assembly 2g of the auxiliary drive 2 is mounted adjacent thereto. The mounting plate 3fm has a screw fastening in the standard hole pattern of the door leaf 3f only in the section close to the hinge. This is the section of the mounting plate 1f m close to the hinge in which the door closer housing 1g is fastened on the mounting plate. In the sections of the mounting plate 3fm away from the hinge, in which the housing 2g of the auxiliary drive 2 as well as the leaf-side lock component 4f are mounted on the mounting plate, the mounting plate 3fm has no screw connection to the door leaf 3f. Advantages thus result in connection with the mounting on standard doors which in the door leaf only have a standard hole pattern in the upper section of the door leaf in the area close to the hinge.

In the same way as in the embodiment example represented in FIGS. 1 to 3, in the embodiment example in FIG. 4 a door leaf-side cover housing 3fh that is continuous over the entire leaf width is also provided, which is formed as a common cover housing, underneath which all of the components mounted on the leaf side are arranged, namely the leaf-side component of the main drive 1, adjacent thereto the leaf-side component of the auxiliary drive 2 and adjacent thereto, in the section furthest away from the hinge, the leaf-side component of the electrical lock 4. Correspondingly, a door frame-side common cover housing 3rh is also provided which has the same length as the door leaf-side cover housing 3fh and is borne on the upper frame beam with ends flush therewith. Underneath this frame-side cover housing 3rh, all of the components mounted on the frame side are arranged, namely the slide rail 1ks of the main drive 1 in the area close to the hinge, adjacent thereto the slide rail 2ks of the auxiliary drive 2 and, in the section furthest away from the hinge, the frame-side component of the electrically switchable lock 4, which is formed as an electrical door opener in the specific case.

### Modified Auxiliary Drive

In FIGS. 5.1 to 5.3 an auxiliary drive 2 is shown which, in the same way as in the embodiment example of the preceding figures, has a drive assembly 2g with a piston rod 2gks, e.g. formed as a pneumatic spring. The difference from the embodiment examples of the preceding figures is that the drive assembly 2g is set to apply pressure, i.e. the piston rod 2gks is pushed into the housing, i.e. pushed into the piston, thus shortened, during the opening of the door, loading the energy storage device. During the closing of the door, with the energy storage device being unloaded, the piston rod is pushed out, i.e. thus lengthened. For this, the bearing of the drive assembly 2g is designed modified correspondingly compared with the embodiment example of the preceding figures. In the case of FIGS. 5.1 to 5.3, the piston rod 2gks acts on a link rod mechanism borne on the bearing framework with a connecting link rod 2kav, which is connected, with one of its ends, to the piston rod 2gks and, with its other end, engages on the angular arm 2ka and is acted on during opening of the door by pulling, when the piston rod 2gks is extended.

As can be seen from FIGS. 5.1 to 5.3, the drive assembly 2g of the auxiliary drive 2 is borne on a bearing framework 2m, which is to be mounted securely on the leaf, in the same way as in the previously described embodiment example, in the case of a leaf-side mounting of the drive assembly 2g. The drive assembly 2g is borne in an articulated manner with its cylindrical housing in a pivot bearing 2kas arranged on the bearing framework 2m. The output end of the piston rod 2gks is borne in an articulated manner on a bearing link rod 2gkv. The bearing link rod 2gkv is supported on its bearing end in a pivot bearing 2gs arranged on the bearing framework 2m. At its free end, the bearing link rod 2gkv has an articulated bearing 2gkg for articulated support of the piston rod 2gks. The slide arm 2ka is also formed as an angular arm in this embodiment example, likewise as a right angle with a first and a second segment in the case represented. The first segment 2kaa is, as can be seen in FIG. 5.1, offset in terms of height vis-à-vis the second segment 2kab. For this, the first segment 2kaa has a height-offset piece 2kah at the vertex end, with the result that the first segment 2kaa is formed substantially L-shaped and protrudes perpendicularly upwards from the vertex end of the second segment 2kab.

The slide 2kag is arranged at the free end of the first segment 2kaa. The second segment 2kab is formed as a bearing segment which is borne with its free end in the pivot bearing 2kas arranged on the bearing framework 2m. The housing of the drive assembly 2g is also borne in the same pivot bearing 2kas. The connecting link rod 2kav connects the articulated bearing 2gkg, in which the output-side end of the piston rod 2gks is supported, to the bearing 2kas arranged in the vertex of the angular arm 2ka, in which the connecting link rod 2kav is borne in an articulated manner with one of its ends in the articulated bearing 2gkg and with its other end in the vertex bearing 2kas.

The height offset of the angular arm 2ka, i.e. the height offset of the lever arms 2kaa and 2kab relative to each other, can be adjusted in the embodiment example represented in FIGS. 6.1 and 6.2. This embodiment example corresponds to the embodiment example of FIGS. 5.1 to 5.3 from the point of view of structure and function. The adjustability of the height offset is effected, as follows from FIGS. 6.1 and 6.2, via an elongated hole-screw connection 2kj of the two arms 2kaa and 2kab. In the embodiment represented two elongated holes are formed in the vertical offset piece 2kah of the first arm 2kaa, in which fastening screws engage which are fixed in fastening holes of the second arm 2kab, e.g. by means of screwing with nuts. They form a clamping connection of the two arms 2kaa and 2kab that can be adjusted in terms of the height position, in order to set the height offset suitably to the height position of the drive assembly 2g relative to the slide rail 2ks.

Modified Drive with Mounting Space M

The embodiment example of FIGS. 7.1 to 7.3 shows a modification of the embodiment example of the drive of the preceding figures. The modification is likewise a drive composed of a main drive 1 and an auxiliary drive 2. The modification consists in the fact that the slide rail 2ks of the auxiliary drive 2 is arranged in a plane on the front side of the slide rail 1ks of the main drive 1, i.e. the slide track of the slide 2kag of the auxiliary drive 2 is in a plane which lies on the front side in front of the slide track of the slide 1ka g of the main drive 1. As can be seen in FIGS. 7.1 to 7.3, the slide track of the slide 2kag of the auxiliary drive 2 can more or less overlap with the slide track of the slide 1ka g of the main drive 1. However, it is important that the two slide tracks are offset parallel to each other towards the front side and thus do not impede each other. This offset relative to each other has the advantage that possible add-on components of the main drive 1, which in conventional slide arm drives are arranged in the slide rail of the drive, such as e.g. a locking mechanism in the open position of the door, a smoke detector or, in the case of double-leaf doors, closing sequence regulation components, can furthermore be arranged in a conventional manner in a mounting space which lies in the slide rail 1ks or in an extension line of the slide track of the slide 1ka g of this slide rail, as the slide rail 2ks of the auxiliary drive 2 is arranged outside this mounting space, i.e. leaves this mounting space free.

The embodiment examples represented in FIGS. 8a-8c and 9 are in each case a door drive which is composed of a main drive 1 and an auxiliary drive 2.

The main drive of the second embodiment example:

The main drive 1 in the case represented is a slide arm door closer with a drive assembly 1a mounted on the leaf F and a force-transmitting mechanism 1k as a slide rail rod system with a slide arm 1ka and a slide rail 1ks. The slide arm 1ka is coupled in a rotationally fixed manner to an output shaft 1w borne in a housing of the drive assembly 1g and guided the slide rail 1ks mounted securely on the frame. The main drive in the embodiment example represented is to be formed as a slide arm door closer with a drive assembly 1g with a closer spring and hydraulic damper.

The auxiliary drive of the second embodiment example:

The auxiliary drive 2 in the case represented is formed from a drive assembly 2g and a force-transmitting rod system 2k. The drive assembly 2g is integrated in a slide rail 2ss and fixed in a secure position. The slide rail 2ss adjoins the slide rail 1ks of the main drive 1. In the case represented, the two rails 1ks and 2ss are formed as sections of a common continuous slide rail. The drive assembly 2g of the auxiliary drive integrated in the section 2ks of the slide rail comprises a spring brake 2f or alternatively or additionally an electric motor. The output 2aa of the spring brake 2f or of the electric motor interacts with the slide 2kag guided in the slide rail 2ks. This is a slide at the free end of the slide arm 2ka. The slide arm 2ka is borne pivotably with its bearing end in a pivot bearing 2kd mounted on the leaf side and guided with its free end via the slide 2kag in the slide rail 2ss. The slide 2kag is connected to the free end of the output 2aa of the drive assembly 2g integrated in the slide rail 2ss. The output 2aa is guided linearly movably in the slide rail 2ss along the guide track of the rail. The slide 2kag is carried along with it. The slide rail 2ss forms an output bearing that is stationary with the drive assembly 2g.

The output 2aa is guided in the guide track of the slide rail and thus is a linear output. In the embodiment example represented, the guide track of the slide rail is linear and extends horizontally. It may be pointed out, however, that the output 2aa is also understood as a linear output if, in a modified embodiment, the guide track of the slide rail is formed as a non-linear curved track. Furthermore it may be pointed out that further modified embodiments are also understood as a linear output, namely in which a gearing mechanism is connected between the primary output of the drive assembly and the output 2aa guided in the guide track of the slide rail. The primary output can here be formed e.g. as a rotary output. It can be formed as a rotating threaded spindle on which a threaded nut runs which is guided linearly in the guide track and drives the slide arm 2ka e.g. by carrying the slide 2kag along with it.

As can be seen from FIGS. 8b and 8c, the slide arm 2ka of the auxiliary drive 2 with the drive assembly 2g can be coupled into and out of the slide rail 2ks.

The coupling-in/out point in the embodiment example of FIGS. 8b, 8c is formed between the free end of the slide arm 2ka and the output member 2aa, guided in the slide rail 2ss, of the drive assembly 2g borne in the slide rail 2ss, i.e. between the connecting end of the slide arm 2ka and the output of the drive assembly 2g.

The coupling-in and -out is effected during the opening and closing process in each case automatically at a specific door opening angle. FIG. 8b shows the door position in the door opening angle in which the coupling-in is effected during the closing process and the coupling-out is effected during the opening process. At door opening angles smaller than this coupling-out and -in angular position the slide arm 2ka is coupled in (see FIGS. 8b and 8a). At door opening angles greater than the coupling-in/out angular position the slide arm is coupled out (see FIG. 8c).

In the coupled-out position the slide arm 2ka in this embodiment example remains on the rod system bearing, i.e. in the case represented in FIG. 8c on the leaf-side pivot bearing 2d, namely in a locked angular position protruding from the leaf F. The locking of the angular position can be effected by a catching mechanism interacting with the slide arm. The catching mechanism is formed in the pivot bearing 2kd. The locked angular position corresponds to the angular position which the slide arm 2ka adopts during coupling-in/out, i.e. the angular position in FIG. 8b. While the slide arm 2ka is being coupled out, the spring brake 2f of the drive assembly 2g remains in the loaded position, in which the coupling-out has been effected. This is the loaded position which the spring brake attained during the opening process with coupled-in slide arm. For this fixing of the spring brake, a fixing mechanism is provided in the area of the drive assembly 2g. It is switched on with the coupling-out of the slide arm 2ka and switched off when the spring brake is released with the coupling-in of the slide arm 2ka.

The coupling-in process between the free end of the slide arm 2ka and the slide 2kg guided in the slide rail 2ks is effected automatically during the process of closing the door at the predetermined door opening angle which is shown in FIG. 8b. The free end of the slide arm 2ka protruding in this angular position moves into the slide rail 2ks with its slide 2kag in this door opening position, namely via a running-in slope, not represented in more detail, through a front-side opening of the slide rail 2ks, and couples with the output member 2aa protruding therein in the standby position and formed as a slide. With the coupling, the spring brake 2f arranged in the slide rail and loaded during the preceding opening process is forcibly released. Through the unloading of the spring brake 2f being effected in such a way, the slide 2aa is driven in the closing direction together with the slide 2kag and slide arm 2ka coupled thereto. The coupled slides 2kag and 2aa in the representation in the figures are moved towards the right and the slide arm 2ka is rotated clockwise about the pivot bearing 1kd. This means that the door leaf F is moved in the closing direction. Finally, it reaches the closed position which is represented in FIG. 8a. In the closed position, the slide arm in turn reaches a catch position, in which it remains until the door is then opened again for entrance. This is effected manually by a pivoting movement of the door leaf F in the opening direction.

During the opening movement of the door leaf the slide arm 2ka is rotated counter-clockwise about the pivot bearing 1kd in the representation in the figures. The slide 2kag with the output slide 2aa is moved in the opening direction, i.e. is moved towards the left in the slide rail in the representation in the figures. As soon as the door leaf reaches the predetermined door opening angle of the coupling-in and -out, which is shown in FIG. 8b, the coupling-out of the slide arm 2ka is effected automatically. The coupled-out slide arm 2ka then remains fixed in the predetermined angular position which it adopts during the coupling-out, protruding from the leaf-side pivot bearing 1kd.

After the coupling-out of the slide arm 2ka, the output slide 2aa also remains in its position which it adopted during the coupling-out, fixed by the already mentioned fixing mechanism. Because of this automatically occurring fixing, the storage spring 2f connected to the output slide 2aa also, as long as the slide arm 2ka is coupled out, remains in the loaded state which the storage spring 2f reached through the preceding opening process with coupled-in slide arm 2ka.

The auxiliary drive 2 is thus loaded during the opening process, as long as the slide arm 2ka is coupled in, i.e. during the opening of the door in the first opening angle range. During the closing process the auxiliary drive 2 aids the closing process by unloading of the spring brake, as soon as the slide arm of the auxiliary drive 2 is coupled in. The aid is effected in the last closing phase, i.e. at the end of the closing process, until the door has reached the closed position.

FIG. 9 shows a modified embodiment example which differs from the embodiment example of FIGS. 8a-8b in that the coupling-in/out point of the slide arm 2ka is formed not between the output of the drive assembly 2g and the connecting end of the slide arm 2ka, but in the area between the pivot bearing 1kd mounted securely on the leaf and the slide arm 2ka in the area of the bearing end of the slide arm. In this modified embodiment too, the slide arm 2ka, as long as it is coupled out, remains in the angular position which it had adopted during the coupling-out. Here too, a fixing mechanism for the angular position of the coupled-out slide arm and a fixing mechanism for the loading of the storage spring 2f are provided. This fixing can be effected via the locking of the slide arm 2ka in the predetermined angular position in the manner of a dead center position, i.e. in a similar way to the embodiment example of FIGS. 1 to 4. This means that, in this embodiment example too, the storage spring 2f remains in the loaded position which it had during the coupling-out of the slide arm 2ka.

It is important in the embodiment examples represented in FIGS. 8 and 9 that the components of the main drive 1 and of the auxiliary drive 2 mounted on the frame side, i.e. the slide rail 1ks of the main drive 1 and the slide rail 2ss with the storage spring 2f borne therein, are covered by a common continuous frame-side cover 3rh. This applies correspondingly to the leaf-side components, i.e. the drive housing 1g of the main drive 1 and the pivot bearing 2kd of the force-transmitting rod system of the auxiliary drive 2. They are covered via a common continuous cover 3fk (not represented in the figures).

The common continuous leaf-side mounting plate 3fm, on which the drive assembly 1g of the main drive 1 and the pivot bearing 2kd of the auxiliary drive 2 are mounted, is particularly advantageous. This mounting plate 3fm is screwed to the door leaf in a standard hole pattern of the door leaf only in its section close to the hinge.

A common continuous frame-side mounting plate 3rm can also be provided for the mounting of the frame-side components.

In these embodiment examples represented in FIGS. 8 and 9 too, an electrically switchable lock 4 with a frame-side component 4r and a leaf-side component 4f can be provided. The frame-side component can be mounted in the common frame-side continuous slide rail. The leaf-side component 4f can be mounted adjacent to the pivot bearing 2kd on the leaf, preferably on the common leaf-side mounting plate on which the pivot bearing 2kd and the drive assembly 1g of the main drive are also mounted.

In a modification of the embodiment example in FIG. 9 the drive assembly can also be arranged on the slide arm 2ka or integrated therein. At the free end of the slide arm 2ka a pinion driven via the drive assembly 2g can be arranged, which is guided in the slide rail 2ss, e.g. meshing on a toothed rack arranged in the slide rail 2ks.

Advantageous embodiments of the drive mechanism are also provided in which the main drive 1 is formed as a slide arm drive, preferably a sliding door arm closer with a closer spring and hydraulic damper, and a slide rail with an electrical fixing mechanism is used as slide arm 1ks, in order to be able to hold the door leaf open via the electrically switchable fixing mechanism. The electrically switchable fixing mechanism can be formed as a unit mounted internally in the slide rail 1ks, which interacts with the slide of the slide arm 1ka. The electrical fixing mechanism can be formed as a retrofit unit. However, it can also be designed as a component of an electrical fixing rail. The electrical fixing rail can be formed as a functional rail of a slide arm door closer program and contain the electrical fixing mechanism.

Further functional rails of a slide arm door closer program can also be used as slide rail 1ks, e.g. slide rails, preferably formed as an electrical fixing rail with smoke detector.

The drive mechanism can also be designed for double-leaf doors, e.g. for a door with an active leaf and an inactive leaf. The drive mechanism on the active leaf side and the drive mechanism on the inactive leaf side can be formed identically, i.e. in each case with an identical main drive 1 and identical auxiliary drive 2. Here the components to be mounted on the frame side and the components to be mounted on the leaf side can preferably be mounted in each case on a common mounting plate which is designed as a single- or multi-component mounting plate continuously over the entire width of the double-leaf door. The frame-side components of the two door leaves can also be covered via a common continuous cover.

The frame-side slide rail of the active leaf drive mechanism and the frame-side slide rail of the inactive leaf drive mechanism can also be designed as a continuous unit, e.g. a continuous slide rail.

In embodiments for double-leaf doors, components of a closing sequence regulation, preferably as a mechanical closing sequence regulation in the slide rail, can also be used as frame-side components and are preferably mounted in the frame-side slide rail of the active leaf and in the frame-side slide rail of the inactive leaf, preferably in a continuous slide rail which extends over the entire width of the double-leaf door. In the case of closing sequence regulation, it is provided that the inactive leaf blocks the closing movement of the active leaf via its slide arm or an element connected to the slide arm. For this, mechanical components, for example push bars or Bowden cables, are provided in the slide rail, which reach along the slide rail from the inactive leaf side to the active leaf side. It is provided in particular that these mechanical components are bypassed on the components of the auxiliary drive. The slide rail can preferably be constructed with two levels or two compartments, wherein the components of the auxiliary drive or the slide elements of the auxiliary drive are guided in the first compartment of the slide rail and the mechanical components, such as for example push bars or Bowden cables, are guided in the second compartment of the slide rail. The two compartments of the slide rail can lie vertically one above the other or can be arranged horizontally next to each other.

### LIST OF REFERENCE NUMBERS

10 Drive mechanism, door closer mechanism consisting of 1 and 2
1 Main drive
1k Force-transmitting rod system
1ka Slide arm
1kag Slide
1ks Slide rail
1g Drive assembly of the main drive, door closer housing
1w Door closer shaft
2 Auxiliary drive
2k Force-transmitting rod system
2ka Slide arm, angular slide arm
2kag Slide
2kae Angular vertex corner
2kas Pivot bearing
2ks Slide rail
2kö Opening
2g Drive assembly of the auxiliary drive, shutting assembly
2gs Pivot bearing
2gkz Piston-cylinder unit
2gk Piston
2gks Piston rod
2gz Cylinder
2gg Hinge connecting 2gk and 2ka
2gf Closer spring
3 Door
3f Door leaf
3r Door frame
3b Door hinge
3a Door axis
3fh Common cover housing on the door leaf side
3rh Common cover housing on the door frame side
3fm Common mounting plate on the leaf side
3rm Common mounting plate on the door frame side

### FIGS. 8a, 8b, 8c and 9

R Frame
F Leaf
1 Main drive
1k Rod system/force-transmitting mechanism
1ks Rail
1ka Slide arm
1kag Slide
1g Drive assembly, door closer housing with closer spring and damper
1w Output shaft
2 Auxiliary drive
2k Rod system/force-transmitting mechanism
2ks Rail
2ka Slide arm
2kag Slide
2g Drive assembly
2f Spring brake
2aa Output of the spring brake
2kd Pivot bearing/hinge bearing

1. A door drive mechanism for a door of a building with a door leaf borne pivotably about a vertical door axis in a stationary frame, the door drive mechanism comprising:
a) a main drive for acting on the door leaf in the direction of the closing movement and/or opening movement and/or closing damping and/or opening damping, the main drive including:
a1) a drive assembly of the main drive; and
a2) a force-transmitting mechanism of the main drive;
b) an auxiliary drive for acting on the door leaf in the direction of the closing movement and/or opening movement and/or closing damping and/or opening damping, the auxiliary drive including:
b1) a drive assembly of the auxiliary drive; and
b2) a force-transmitting mechanism of the auxiliary drive,
wherein the main drive has one or more components to be mounted on the door leaf side and one or more components to be mounted on the frame side, which can be and/or are connected via a force-transmitting connecting mechanism of the force-transmitting mechanism of the main drive, and
wherein the auxiliary drive has one or more components to be mounted on the door leaf side and one or more components to be mounted on the frame side, which can be or are connected via a force-transmitting connecting mechanism of the force-transmitting mechanism of the auxiliary drive, and
wherein:
(i) the components of the main drive and of the auxiliary drive to be mounted on the door leaf side are borne in or on a common and/or continuous housing mechanism and/or bearing framework mechanism and/or mounting plate mechanism to be mounted on the door leaf side and/or are covered by a common and/or continuous cover to be mounted on the door leaf side;
and/or
(ii) the components of the main drive and of the auxiliary drive to be mounted on the frame side are borne in or on a common and/or continuous housing mechanism and/or bearing framework mechanism and/or mounting plate mechanism to be mounted on the frame side and/or are covered by a common and/or continuous cover to be mounted on the frame side;
and/or
(iii) the components of the main drive and of the auxiliary drive to be mounted on the door leaf side are formed to be mounted concealed and/or internally in the leaf;
and/or
(iv) the components of the main drive and of the auxiliary drive to be mounted on the frame side are formed to be mounted concealed and/or internally in the frame.

2. The door drive mechanism according to claim 1, wherein the common and/or continuous housing mechanism to be mounted on the frame side and/or the common and/or continuous housing mechanism to be mounted on the leaf side is or are formed surrounding the components borne therein in their entirety on several sides.

3. The door drive mechanism according to claim 1, wherein the common and/or continuous bearing framework mechanism to be mounted on the frame side and/or to be mounted on the leaf side is formed as a three-dimensional body, on or in which the components borne thereon can be fastened, optionally by fastening the components to each other.

4. The door drive mechanism according to claim 1, wherein the common and/or continuous mounting plate mechanism to be mounted on the door leaf side and/or to be mounted on the frame side is formed as a plate-shaped element, on the upper side of which the components borne thereon can be arranged.

5. The door drive mechanism according to claim 1, wherein the common and/or continuous cover to be mounted on the frame side and/or to be mounted on the leaf side is formed as a U-shaped cover or as a cap-shaped cover, below or inside which the components covered thereby can be arranged.

6. The door drive mechanism according to claim 1, wherein the components of the main drive and/or of the auxiliary drive formed and/or provided to be mounted concealed and/or internally in the leaf and/or in the frame are accommodated in or on a common and/or continuous receiver mechanism, which in the manner of a housing mechanism and/or bearing framework mechanism and/or mounting plate mechanism, which is formed as a mechanism for concealed and/or internal mounting in the door leaf or in the frame.

7. The door drive mechanism according to claim 1, wherein components of the main drive and of the auxiliary drive adjoining each other and to be mounted on the leaf side have fastening points which are formed for the mutual fastening of the components adjoining each other, and/or components of the main drive and of the auxiliary drive adjoining each other and to be mounted on the frame side have fastening points which are formed for the mutual fastening of the components adjoining each other.

8. The door drive mechanism according to claim 1, wherein components of the main drive and of the auxiliary drive adjacent to each other and to be mounted on the leaf side are fastened to or on connecting elements which connect these components to each other, and/or components of the main drive and of the auxiliary drive adjacent to each other and to be mounted on the frame side are fastened to or on connecting elements which connect these components to each other.

9. The door drive mechanism according to claim 1, wherein the one or more component(s) of the auxiliary drive to be mounted on the frame side is or are to be mounted in a mounting plane which is arranged on the front side or on the back side or above the upper side or below the underside of the one or more component(s) of the main drive to be mounted on the frame side.

10. The door drive mechanism according to claim 9, wherein the one or more component(s) of the auxiliary drive to be mounted on the frame side and the one or more component(s) of the main drive to be mounted on the frame side are borne in or on the common and/or continuous housing mechanism and/or bearing framework mechanism and/or mounting plate mechanism to be mounted on the frame side or are covered by the common and/or continuous cover to be mounted on the frame side or in the case of concealed and/or internal mounting of the components of the main drive and of the auxiliary drive to be mounted on the frame side are arranged in the common and/or continuous receiver mechanism formed in the frame.

11. The door drive mechanism according to claim 1, wherein
the drive assembly of the main drive is mounted on the door leaf side and the slide rail of the force-transmitting mechanism of the main drive is mounted on the frame side,
the auxiliary drive has one or more components mounted on the frame side—called component mechanism of the auxiliary drive mounted on the frame side in the following—which are mounted on the frame side in such a way that a mounting space remains free and/or is formed, which is determined for the mounting of at least one or more add-on functional components of the main drive interacting with the slide and/or the slide arm of the main drive and to be mounted on the frame side—called add-on functional component mechanism of the main drive in the following,
wherein the mounting space extends from the slide rail of the main drive and/or from the movement track of the slide of the main drive guided in the slide rail or from the movement track of a part connected immovably to the slide of the main drive in the direction of the end of the door frame away from the hinge.

12. The door drive mechanism according to claim 1, wherein the mounting space extends in a direction which is flush with or which has a parallel or angled offset relative to the direction of the movement track of the slide of the main drive.

13. The door drive mechanism according to claim 11, wherein at least a part of the mounting space or all or a majority of the mounting space
is arranged on the upper side of the slide rail of the main drive and/or of the component mechanism of the auxiliary drive mounted on the frame side or of a part of this component mechanism and/or
is arranged on the underside of the slide rail of the main drive and/or of the component mechanism of the auxiliary drive mounted on the frame side or of a part of this component mechanism and/or
is arranged on the front side of the slide rail of the main drive and/or of the component mechanism of the auxiliary drive mounted on the frame side or of a part of this component mechanism and/or
is arranged on the back side of the slide rail of the main drive and/or of the component mechanism of the auxiliary drive mounted on the frame side or of a part of this component mechanism and/or
is arranged inside the slide rail of the main drive and/or the component mechanism of the auxiliary drive mounted on the frame side or a part of this component mechanism.

14. The door drive mechanism according to claim 11, wherein at least a part of the mounting space is covered towards the outside by a cover plate or a cover housing.

15. The door drive mechanism according to claim 11, wherein at least a part of the mounting space is arranged inside a housing of the slide rail of the main drive and/or a housing of the drive assembly of the auxiliary drive or a housing of the slide rail of the auxiliary drive.

16. The door drive mechanism according to claim 1, wherein
the components to be mounted on the door leaf side are formed by the drive assembly of the main drive and by the drive assembly of the auxiliary drive, and
the components to be mounted on the frame side are formed by a part of the force-transmitting mechanism of the main drive to be mounted on the frame side and by a part of the force-transmitting mechanism of the auxiliary drive to be mounted on the frame side.

17. The door drive mechanism according to claim 1, wherein
the components to be mounted on the door leaf side are formed by the drive assembly of the main drive and a part of the force-transmitting mechanism of the auxiliary drive to be mounted on the door leaf side, and
the components to be mounted on the frame side are formed by a part of the force-transmitting mechanism of the main drive to be mounted on the frame side and by the drive assembly of the auxiliary drive.

18. The door drive mechanism according to claim 1, wherein
the components to be mounted on the door leaf side are formed by a part of the force-transmitting mechanism of the main drive to be mounted on the door leaf side and by the drive assembly of the auxiliary drive, and
the components to be mounted on the frame side are formed by the drive assembly of the main drive and a part of the force-transmitting mechanism of the auxiliary drive to be mounted on the frame side.

19. The door drive mechanism according to claim 1, wherein
the components to be mounted on the door leaf side are formed by a part of the force-transmitting mechanism of the main drive to be mounted on the door leaf side and a part of the force-transmitting mechanism of the auxiliary drive to be mounted on the door leaf side, and
the components to be mounted on the frame side are formed by the drive assembly of the main drive and the drive assembly of the auxiliary drive.

20. The door drive mechanism according to claim 1, wherein the door drive mechanism has an electrically switchable lock which is formed by a lock component to be mounted on the frame side and a lock component to be mounted on the leaf side, wherein one or both of the lock components is or are formed as (a) structural unit(s) which is or are formed separately from the components of the main drive and/or auxiliary drive or is or are formed as (a) common or connected structural unit(s) with in each case at least one of the components of the main drive and/or of the auxiliary drive.

21. The door drive mechanism according to claim 20, wherein the electrically switchable lock comprises an electrically switchable lock component and a mechanical counter component, wherein one of the lock components is to be mounted on the frame side and the other lock component is to be mounted on the leaf side.

22. The door drive mechanism according to claim 20, wherein the lock component to be mounted on the frame side is formed such that it can be mounted adjacent to and/or adjoining the drive assembly of the auxiliary drive to be mounted on the frame side or the part of the force-transmitting mechanism of the auxiliary drive to be mounted on the frame side.

23. The door drive mechanism according to claim 20, wherein the lock component to be mounted on the leaf side is formed such that it can be mounted adjacent to and/or adjoining the drive assembly of the auxiliary drive to be mounted on the leaf side or the part of the force-transmitting mechanism of the auxiliary drive to be mounted on the leaf side.

24. The door drive mechanism according to claim 20, wherein the lock component to be mounted on the door leaf side and the components of the main drive and of the auxiliary drive to be mounted on the door leaf side are borne in or on the common and/or continuous housing mechanism and/or bearing framework mechanism and/or mounting plate mechanism to be mounted on the door leaf side and/or are covered by the common and/or continuous cover to be mounted on the door leaf side.

25. The door drive mechanism according to claim 20, wherein the lock component to be mounted on the frame side and the components of the main drive and of the auxiliary drive to be mounted on the frame side are borne in or on the common and/or continuous housing mechanism and/or bearing framework mechanism and/or mounting plate mechanism to be mounted on the frame side and/or are covered by the common and/or continuous cover to be mounted on the frame side.

26. The door drive mechanism according to claim 1, wherein the force-transmitting mechanism of the auxiliary drive has a rod system formed as a slide arm or scissor arm and a rod system bearing interacting with the rod system, wherein the rod system bearing is formed as a slide rail or pivot bearing and wherein the force-transmitting mechanism can be coupled in and out automatically with the drive assembly of the auxiliary drive during the opening and closing process,
by forming the coupling-in/out point between the rod system and the rod system bearing, or
by forming the coupling-in/out point between the rod system and the drive assembly of the auxiliary drive.

27. The door drive mechanism according to claim 1, wherein the rod system bearing of the auxiliary drive, which is formed as a slide rail formed for the coupling-in/out or as a pivot bearing formed for the coupling-in/out, is supported
on the rod system bearing of the main drive formed as a slide rail or pivot bearing
or
on the drive assembly of the main drive.

28. The door drive mechanism according to claim 1, wherein the drive assembly of the auxiliary drive is borne in a fastening bearing which is supported
on a bearing framework and/or a bearing plate and/or a receiver housing of the drive assembly of the main drive or
on a bearing framework and/or a bearing plate and/or a receiver housing of the rod system bearing of the main drive formed as a slide rail or pivot bearing.
